(19) United States
(12) Patent Application Publication
(10) Pub. No.: US 2023/0217930 A1
(43) Pub. Date: Jul. 13, 2023

(54) HYDROLYSATE BASED BIOSTIMULANT COMPOSITIONS DERIVED FROM METHANOTROPH, METHODS, AND APPLICATIONS THEREOF

(71) Applicant: STRING BIO PRIVATE LIMITED, Bangalore (IN)

(72) Inventors: Rajeev KUMAR SARMA, Bangalore (IN); Uday KASHINATH AVALAKKI, Bangalore (IN); Ravindra BABU BONDALAKUNTA, Bangalore (IN); Prashanth MURALIDHAR UDAGATTI, Bangalore (IN); Vinod MUNISANJEEVAIAH LAKSHMI DEVI KUMAR, Bangalore (IN); Ezhilkani SUBBIAN, Bangalore (IN); Pavithra GJ, Bangalore (IN); Ram SARAN CHAURASIYA, Bangalore (IN)

(21) Appl. No.: 17/999,894

(22) PCT Filed: May 28, 2021
(86) PCT No.: PCT/IB2021/054710

§ 371 Date: Nov. 25, 2022

(30) Foreign Application Priority Data
May 28, 2020 (IN) 202041022410

(51) Int. Cl. A01N 63/20; A01P 21/00

(52) U.S. Cl. CPC A01N 63/20; A01P 21/00

(57) ABSTRACT

The present disclosure relates to protein hydrolysate based biostimulant composition derived from methanotrophic bacteria, and methods for enhancing agricultural productivity. In particular, the compositions disclosed herein comprise a protein-derived component in an amount of about 30% or less with respect to weight of the composition, wherein said protein-derived component is obtained from a methanotrophic bacterium. The present biostimulant composition finds applications in methods for improving plant performance along with methods for reducing the need of external chemical fertilizer-based inputs for plant growth.

### TECHNICAL FIELD

The instant disclosure is in the field of biosciences, particularly focused towards biotechnology, agricultural science and environmental science. The disclosure particularly relates to methanotroph derived hydrolysate based biostimulant composition, and methods for improving plant performance and agricultural productivity by employing the same. Said biostimulant also helps in reducing the need of external chemical fertilizers for plant growth and survival.

### BACKGROUND OF THE DISCLOSURE

Increasing agricultural production is an immediate need in today's world. The global population is projected to reach 9.6 billion by 2050. To meet the needs of the increasing population in coming years, agricultural production must be increased by about 60-70 percent from the current level.

The growing scarcity of natural resources such as land, water and energy resources underline the fact that global agriculture will have to cope with the challenge of increasing the agricultural productivity. An additional challenge is also to reduce the usage of chemical/synthetic fertilizers for agricultural production. For instance, world consumption of NPK—nitrogen (N), phosphorus expressed as phosphate (P₂O₅) and potassium expressed as potash (K₂O) was 292 million tonnes in 2016 and expected to increase to 318 million tonnes by 2022. The demand for NPK based chemical fertilizers is growing annually on average by 2.2%, from 2015 to 2020 (FAO 2019; World fertilizer trends and outlook to 2022; Rome). Continued and increasing use of chemical/synthetic fertilizers pose severe environmental threat. For instance, long term use of chemical fertilizer alters soil pH and microflora and leads to increase in pests and plant pathogens. This in turn negatively affects the beneficial microbial community in soil. As chemical fertilizers are highly soluble in water, they leach out to ground water and pollute water table. Excess use of chemical fertilizers also depletes essential nutrients in soil. Further, food crops produced in such soil typically have less vitamin and mineral content.

Thus, one of the challenges is to continually improve the availability and uptake of nitrogen, phosphorous and potassium in plants/crops so that the need for chemical fertilizers can be reduced. Another challenge is also to provide better approaches which could lead to an improvement in the overall development and growth/performance of plants to meet the challenge of increased agricultural productivity as discussed above.

Thus, there is an immense need to address some of the above important concerns/challenges to improve agricultural productivity in an environment friendly manner. The present disclosure addresses said need through a unique approach.

### SUMMARY

The present disclosure relates to a hydrolysate based biostimulant composition derived from methanotrophic bacteria.

In embodiments of the present disclosure, the hydrolysate based biostimulant composition comprises a protein-derived component in an amount of about 30% or less with respect to weight of the composition, wherein said protein-derived component is obtained from a methanotrophic bacterium.

In embodiments of the present disclosure, the protein-derived component comprises proteins, peptides, amino acids, enzymes or hormones, or any combination thereof.

In embodiments of the present disclosure, the protein-derived component comprises essential amino acids wherein lysine is in an amount of about 2% to 6%, threonine is in an amount of about 2% to 3%, methionine is in an amount of about 1% to 2%, tryptophan is in an amount of about 0.1% to 1%, histidine is in an amount of about 1% to 4%, valine is in an amount of about 5% to 10%, phenylalanine is in an amount of about 5% to 10%, isoleucine is in an amount of about 5% to 10%, leucine is in an amount of about 3% to 4%, proline is in an amount of about 5% to 13% and glycine is in an amount of about 1% to 8.5%, with respect to weight of total amino acids in the protein-derived component.

In embodiments of the present disclosure, protein-derived component comprises peptides (polypeptides, oligopeptides or a combination thereof) having a size greater than 45 kDa (kilodaltons) in an amount of less than 5%, peptides having a size of about 17 kDa to 45 kDa in an amount of less than 5%, peptides having a size of about 1 kDa to 15 kDa in an amount of less than 20%, and peptides having a size lower than 1 kDa in an amount of more than 50%, with respect to amount of total peptides in the protein-derived component.

In embodiments of the present disclosure, the hydrolysate based biostimulant composition comprises micronutrients calcium at about 1% to 25%, magnesium at about 1% to 30%, boron at about 0.001% to 1%, iron at about 0.001% to 1% and sodium at about 1% to 20%, with respect to weight of total micronutrients in the composition.

In embodiments of the present disclosure, the methanotrophic bacterium is a gammaproteobacterial methanotroph.

In embodiments of the present disclosure, the gammaproteobacterial methanotroph is a type I or type X methanotroph belonging to genus selected from the group comprising Methylococcus, Methylomonas, Methylobacter, Methyloglobulus, Methylovulum, Methylomicrobium, Methylosarcina, Methylosphaera, Methyloprofundus, Methylosoma, Methylocucumis, Methyloparacoccus, Methylogaea, Methylomagnum, Methyloterricola, Methylohalobius, Methylomarinum, Methylomarinovum, Methylocaldum, Methylothermus, Crenothrix and combinations thereof.

In embodiments of the present disclosure, the methanotrophic bacteria is Methylococcus capsulatus.

In embodiments of the present disclosure, the hydrolysate based biostimulant composition is in a solid form or a liquid form.

In embodiments of the present disclosure, the hydrolysate based biostimulant composition comprises protein derived component, non-protein metabolite, culture media component and optionally an agriculturally acceptable excipient.

In embodiments of the present disclosure, said hydrolysate based biostimulant composition:
a. improves or enhances performance of plant,
b. increases availability or efficient utilization of at least one of nitrogen, phosphorus and potassium by the plant,
c. reduces need for external addition of at least one nutrient selected from nitrogen, phosphorus and potassium, either individually or as part of a fertilizer, or
d. any combination of a. to c.

The present disclosure further relates to a method of improving or enhancing plant performance, said method comprising contacting or applying the biostimulant composition as described above, to a plant.

In embodiments of the present disclosure, the biostimulant composition is contacted with or applied to the plant through its soil, or through aerial or non-aerial parts of the plant selected from the group comprising root, shoot, leaf, flower, anther, stigma, stamen, fruit, seed and combinations thereof.

In embodiments of the present disclosure, the biostimulant composition improves or enhances the plant performance by about 1% to about 500% or by about 1.5 folds to about 10 folds when compared to a respective performance of a plant not contacted with the biostimulant composition as described above.

The present disclosure further relates to a method of reducing need of external addition of at least one nutrient or nutrient carrying fertilizer for growth or survival of a plant, said method comprising contacting or applying the biostimulant composition as described above, to the plant, wherein the nutrient is selected from the group comprising nitrogen, phosphorus, potassium and combinations thereof.

In embodiments of the present disclosure, the method reduces need for external addition of at least one of nitrogen, phosphorus and potassium for growth or survival of the plant, by at least about 10% to 100%, when compared to the need for addition of respective nitrogen, phosphorus and potassium in a plant not contacted with the biostimulant composition as described above.

The present disclosure further relates to a process of preparing the biostimulant composition as described above, said process comprising hydrolysing a biomass comprising methanotrophic bacteria cells and optionally adding agriculturally acceptable excipient, to obtain the biostimulant composition.

In embodiments of the present disclosure, the process of preparing the biostimulant composition comprises:
hydrolysing the biomass comprising methanotrophic bacteria cells by a cell disruption method selected from physical method, mechanical method, chemical method, enzymatic method, or any combination thereof to obtain a hydrolysate comprising soluble and non-soluble fractions,
   wherein the biomass comprising methanotrophic bacteria cells is obtained by culturing the methanotrophic bacteria in a cell culture media;
separating the soluble and non-soluble fractions;
processing the soluble fraction of the hydrolysate; and
optionally adding agriculturally acceptable excipient, to obtain the biostimulant composition as described above.

In embodiments of the present disclosure, the process of preparing the biostimulant composition employs Methylococcus capsulatus.

The present disclosure also relates to use of the plant biostimulant composition as described above, for:
a. improving or enhancing plant performance, or
b. increasing availability or efficient utilization of at least one of nitrogen, phosphorus and potassium by the plant,
c. reducing need of external addition of at least one nutrient or nutrient carrying fertilizer for growth or survival of a plant, or
d. any combination of a. to c.

The present disclosure further provides a biostimulant product comprising:
a) the hydrolysate based biostimulant composition as described above; and
b) a composition comprising a microbial consortium of whole cells, wherein at least 50% whole cells are methanotrophic bacteria cells.

### BRIEF DESCRIPTION OF FIGURES

FIG. 1 illustrates effect of the present methanotroph derived protein hydrolysate based biostimulant on yield improvement in Spinach. Foliar and soil application of present biostimulant composition resulted in 25% improvement in produce biomass.

FIG. 2 illustrates effect of present methanotroph derived protein hydrolysate based biostimulant on Cluster bean. Foliar application of present biostimulant composition resulted in ˜23% pod yield improvement.

FIG. 3 illustrates effect of present methanotroph derived protein hydrolysate based biostimulant on nutrient uptake in Spinach. Soil application of said biostimulant composition resulted in significant improvement in uptake of nitrogen, phosphorus and potassium by plants.

FIG. 4 illustrates effect of present methanotroph derived protein hydrolysate based biostimulant on field bean. Foliar application of said biostimulant composition resulted in ˜25% pod yield improvement over commercial control.

FIG. 5 illustrates effect of present methanotroph derived protein hydrolysate based biostimulant on Bengal gram. Foliar application of said biostimulant composition resulted in 15% pod yield improvement over commercial control.

FIG. 6 illustrates effect of present methanotroph derived protein hydrolysate based biostimulant on coriander. Foliar application of said biostimulant composition resulted in ˜23% improvement in biomass over commercial control.

FIG. 7 illustrates effect of present methanotroph derived protein hydrolysate based biostimulant on Spinach. Foliar application of said biostimulant composition resulted in ˜11% improvement in biomass over commercial control.

FIG. 8 illustrates effect of present methanotroph derived protein hydrolysate based biostimulant on improving SPAD index (chlorophyll content) in Spinach.

FIG. 9 illustrates effect of present methanotroph derived protein hydrolysate based biostimulant on dietary fiber and protein content in Spinach.

FIG. 10 illustrates effect of present methanotroph derived protein hydrolysate based biostimulant on root growth and early seedling establishment in paddy.

FIG. 11 illustrates effect of methanotroph derived protein hydrolysate based biostimulant on root and shoot biomass of Radish. The results shown are from 5 biological replicates and effect in the plants applied with said biostimulant was compared with respective controls. Student's t-test: *P<0.05; **P<0.01. Error bars indicate mean±SE.

FIG. 12 illustrates effect of methanotroph derived protein hydrolysate based biostimulant on fruit number in Tomato. The results shown are from 5-10 biological replicates and effect in the plants applied with said biostimulant was compared with respective controls. Error bars indicate mean±SE.

### DESCRIPTION

In view of the limitations/challenges discussed above, the present disclosure aims at addressing the need for products and methods for improving agricultural productivity in an environment friendly approach using a technological solution.

Particularly, an objective of the present disclosure is to provide products and methods for enhancing/improving plant performance. More particularly, an objective of the present disclosure is to enhance/promote plant growth and achieve an improvement in the overall growth and development/performance of plants, thereby improving agricultural productivity.

Another objective of the present disclosure is to increase the availability or better the utilization/uptake of nitrogen, phosphorous and/or potassium in plants.

Still another objective of the present disclosure is to reduce the use/application of synthetic or chemical fertilizer-based inputs for agricultural activity by employing an environment friendly/biological approach. Typically, such chemical fertilizers cause adverse effect to the soil, environment and the water table, thereby impacting the overall ecosystem. Providing environment friendly/biological products and methods that reduce a plant's dependence on chemical/synthetic fertilizers, is an example of innovative solution to this issue. More particularly, an objective of the present disclosure is to reduce the use/application of chemical fertilizer-based inputs for agricultural activity by increasing the availability or uptake of nitrogen, phosphorous, potassium or any combination thereof, in the plants in an environment friendly/biological manner.

Thus, to summarize the objectives, the present disclosure aims to achieve simultaneous increase in availability or uptake of nitrogen, phosphorous and/or potassium in plants, reduction in application of chemical fertilizer-based inputs, and promoting overall plant growth and performance in an environment friendly/biological manner, as a means for improving agricultural productivity.

Accordingly, the present disclosure intends to provide a simple, economical, sustainable and environment friendly solution for simultaneously addressing the aforesaid needs/objectives.

Before going into greater detail, provided below are definitions of some terms used throughout the present disclosure.

As used in the present disclosure, the term “methanotroph(s)” or “methanotroph” or “methanotrophs” refer to prokaryotic cell that use methane as their primary and sole source of carbon and energy. In some embodiments of the present disclosure, methanotrophs employ methane as the sole source of carbon and energy. In some embodiments of the present disclosure, methanotrophs comprise methanotrophic bacteria.

As used in the present disclosure, the term ‘gammaproteobacterial methanotroph’ refers to methanotrophs that belong to the class of Gammaproteobacteria. These comprise of type I/type X methanotrophs. In some embodiments of the present disclosure, gammaproteobacterial methanotrophs include members of the family Methylococcaceae. An example of one such gammaproteobacterial methanotroph is Methylococcus capsulatus (also referred to herein as M. capsulatus).

As used in the present disclosure, the terms/phrases ‘improving plant performance’, ‘enhancing plant performance’, ‘promoting plant growth’ and the likes refer to stimulating/promoting one or more plant attributes important for plant growth or survival, selected from but not limited to biomass production, yield, photosynthetic activity, nutritional value, nutrient use efficiency, and improvement in plant specific metabolites, or any combination thereof. The improvement or enhancement of the plant performance or plant growth comprises having a stimulating/promoting effect on plant as measured by outcomes selected from but not limited to: increase in number, size or quality of below ground or aerial biomass selected from a group comprising root, shoot, leaf, flowers, anthers, stigma, stamens, fruits and seeds or any combination thereof, increase in photosynthetic activity or chlorophyll content, increase in protein, dietary fibre, β-carotene or essential oil content, secondary metabolite(s) or any combination thereof, or efficient absorption or utilization of available or externally provided nutrients or minerals.

As used in the present disclosure, the terms ‘increase’, ‘increased’, ‘increasing’, ‘enhance’, ‘enhanced’, ‘enhancing’, ‘promote’, ‘promoted’, ‘promoting’, ‘improve’, ‘improved’, or ‘improving’ or their commonly known synonyms, are used interchangeably and refer to their usual meaning known in the art. In the context of the attributes with respect to plant growth or survival, these terms are used herein to emphasize on the positive effect that the composition(s) or method(s) of the present disclosure has on the plant, that allows plant for improved growth and development or better survival, when compared to its previous setting without use of the composition(s) or method(s) of the present disclosure.

As used in the present disclosure, the term ‘cells’, ‘whole cells’ or ‘biomass of cells’ can be used interchangeably and refers to the collection or mass of microorganisms. In some embodiments of the present disclosure, the cells refer to the collection of methanotrophic bacterial cells. In some embodiments of the present disclosure, the cells refer to the collection of methanotrophic bacterial cells and non-methanotrophic cells. In some embodiments of the present disclosure, the cells refer to the collection of methanotrophic bacterial cells alone or in combination with plant growth-promoting microorganism(s).

As used in the present disclosure, the term ‘microbial consortium’, ‘bacterial consortium’ or ‘consortium of microorganisms’ or just ‘consortium’, all used interchangeably in the present disclosure, comprises a group/combination of two or more microorganisms functioning symbiotically or independently, wherein at least one of the microorganisms is a methanotroph. In some embodiments of the present disclosure, the microbial consortium comprises a combination of two or more species of methanotrophic bacteria. In some embodiments of the present disclosure, the microbial consortium comprises one or more gammaproteobacterial methanotrophs, and thus the consortium can be completely made up of only gammaproteobacterial methanotrophs. In other embodiments of the present disclosure, the microbial consortium comprises a combination of at least one methanotrophic bacterium and at least one plant growth-promoting microbe (PGPM). In some embodiments of the present disclosure, the microbial consortium comprises a combination of two or more methanotrophic bacteria and at least one plant growth-promoting microbe (PGPM).

As used in the present disclosure, the term ‘optionally’, ‘optional’ and the likes mean that said component or feature may or may not be present as a part of the compositions or methods of the disclosure. Products and methods both with or without the optional feature(s) form a part of the present disclosure.

As used in the present disclosure, the term ‘plant’, ‘crop’ and the likes are used interchangeably and refer to plants under kingdom Plantae in general. In a preferred embodiment, the plants are agricultural plants, horticultural plants, cash crops, indoor plants, floriculture plants, plantation crops, spice crops, and combinations thereof.

As used in the present disclosure, the term ‘nitrogen availability’ refers to increasing the availability of nitrogen or enabling better utilization of nitrogen to the plants. In some embodiments, the nitrogen availability is achieved by increasing the availability of nitrogen or enabling better uptake/utilization of nitrogen by the plants in the form of ammonia, nitrate, protein, amino acids, peptides, nucleic acids etc. from the hydrolysate based biostimulant composition described herein or from other sources such as glutamine, ammonium, urea, sulphur coated urea, methylene urea, polymer coated urea, isobutylidene diurea nitrate, nitrite, ammonium containing molecules, nitrate containing molecules or nitrite containing molecules, or any combinations thereof.

As used in the present disclosure, the term ‘phosphorous availability’ refers to increasing the availability or enabling better utilization of phosphorous to the plants. In some embodiments, the phosphorous availability is achieved by increasing the availability of phosphorous or enabling better uptake/utilization of phosphorous by the plants in the form of phosphorous or phosphorous based compounds from the hydrolysate based biostimulant composition described herein or from sources comprising diammonium phosphate, monoammonium phosphate, single super phosphate, ammonium dihydrogen phosphate, ammonium phosphate, super phosphate, tricalcium phosphate or any combinations thereof as a source of phosphate.

As used in the present disclosure, the term ‘potassium availability’ refers to increasing the availability or enabling better utilization of potassium to the plants. In some embodiments, the potassium availability is achieved by increasing the availability of potassium or enabling better uptake/utilization of potassium by the plants in the form of potassium from the hydrolysate based biostimulant composition described herein or from sources comprising but not limited to murate of potash, sulphate of potash, potassium nitrate, sulfate potash magnesia, kainite or any combinations thereof as a source of potassium.

As used in the present disclosure, the terms “methanotroph derived composition”, “methanotroph derived protein hydrolysate composition”, “methanotroph derived protein hydrolysate based biostimulant”, “methanotroph derived protein hydrolysate based biostimulant composition”, “hydrolysate composition”, “hydrolysate based product”, “hydrolysate based biostimulant composition”, “protein hydrolysate based biostimulant composition”, “biostimulant composition”, “plant biostimulant composition” and “protein hydrolysate biostimulant composition” are used interchangeably and refers to the products of the present disclosure. Thus, the term biostimulant with or without any other accompanying term is meant to provide the same meaning, which is ordinarily known to a person skilled in the art, for example that of a biological or biologically derived composition that is applied to plants to enhance their characteristics, productivity or efficiency. Similarly, it also encompasses compositions that include extract or lysate derived from microorganisms which when applied to plants or the rhizosphere stimulate natural processes to benefit nutrient uptake, nutrient use efficiency, and/or crop quality, independently of its nutrient content. Particularly in the context of the present disclosure, the term biostimulant means any hydrolysate composition or extract derived from at least one microorganism, and is useful for a plant and provides at least one benefit that impacts the overall performance, characteristics, productivity or efficiency of the plant. Further, in some embodiments of the present disclosure, the compositions comprise an agriculturally acceptable excipient(s) as described herein. In other embodiments of the present disclosure, the compositions lack an agriculturally acceptable excipient(s).

As used in the present disclosure, the term “by weight of composition” or “with respect to weight of the composition” encompasses amount (% values) of a component/ingredient/constituent present relative to the total composition in any one of the measurement units selected from weight/weight (w/w), weight/volume (w/v) and volume/volume (v/v) depending on the form of the composition. Said measurement units are well-known/understood to a person skilled in the art and have conventionally employed meanings. In some embodiments, when the hydrolysate composition of the present disclosure is formulated as a liquid formulation/product, the amount (%) of protein-derived component can be according to the units w/v or v/v. In some embodiments, when the hydrolysate composition of the present disclosure is formulated as a solid formulation/product, the amount (%) of protein-derived component can be according to the units w/w or w/v.

As used in the present disclosure, the term “with respect to weight of total amino acids in the protein-derived component” or “by weight of total amino acids in the protein-derived component” encompasses amount (%) of recited amino acid(s) present relative to the total amino acids form a part of the protein-derived component.

As used in the present disclosure, the term “with respect to amount of total peptides in the protein-derived component” or “with respect to distribution of total peptides in the protein-derived component” encompasses amount (%) of recited peptide(s) with a specific size range/value relative to the total amount/size distribution of peptides in the protein-derived component.

The present disclosure provides methanotrophic organism as means for developing products and methods to achieve the objectives discussed above.

In particular, the present disclosure provides methanotroph derived compositions. A product derived by hydrolyzing a composition or biomass comprising methanotroph whole cells is provided. Particularly, the present disclosure provides a hydrolysate based biostimulant composition comprising a protein-derived component, wherein said protein-derived component is obtained from a methanotrophic bacterium. Accordingly, when applied to a plant, said hydrolysate based biostimulant composition improves or enhances performance of the plant. Simultaneously, said biostimulant composition promotes an increase in availability or uptake of nitrogen, phosphorous and/or potassium in plants, reduction in application of chemical fertilizer-based inputs and/or micronutrients inputs, and enhancing overall plant growth and performance.

The composition(s), their use and associated method(s) of the present disclosure are further described in greater detail in the following embodiments. For the sake of brevity, identical embodiments may not be repeated for each of the different composition(s), use(s) or method(s) described herein. However, any combination of an embodiment captured anywhere in this disclosure with any other embodiment captured elsewhere in this disclosure, fall wholly within the ambit of the present disclosure. Such combinations can therefore be taken into account to derive complete meaning of the aspects described herein.

### Biostimulant Composition

The present disclosure provides a hydrolysate based biostimulant composition comprising a protein-derived component, for improving plant performance and reducing the need of chemical or synthetic fertilizers normally used in the course of agricultural activities.

Particularly, a hydrolysate based biostimulant composition comprising a protein-derived component is provided, wherein said protein-derived component is obtained from a methanotrophic bacterium.

In some embodiments, a hydrolysate based biostimulant composition comprising a protein-derived component is provided, wherein said protein-derived component is obtained by hydrolyzing a biomass comprising methanotrophic bacterial cells.

More particularly, the present disclosure provides a hydrolysate based biostimulant composition comprising a protein-derived component in an amount of about 30% or less with respect to weight of the composition; wherein said protein-derived component is obtained from a methanotrophic bacterium.

In some embodiments, the present disclosure provides a hydrolysate based biostimulant composition comprising a protein-derived component in an amount of about 30% or less with respect to weight of the composition; wherein said protein-derived component is obtained by hydrolyzing a biomass comprising methanotrophic bacterial cells.

In some embodiments, the biostimulant composition comprises the protein-derived component in an amount of about 20% or less with respect to weight of the composition.

In some embodiments, the biostimulant composition comprises the protein-derived component in an amount of about 10% or less with respect to weight of the composition.

In some embodiments, the biostimulant composition comprises the protein-derived component in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29% or 30%, with respect to weight of the composition.

In some embodiments, the biostimulant composition comprises the protein-derived component in an amount ranging from about 0.01% to 30% with respect to weight of the composition.

In some embodiments, the biostimulant composition comprises the protein-derived component in an amount ranging from about 0.01% to less than 10% with respect to weight of the composition.

In some embodiments, the biostimulant composition comprises the protein-derived component in an amount ranging from about 0.01% to 10% with respect to weight of the composition.

In some embodiments, the biostimulant composition comprises the protein-derived component in an amount ranging from about 0.01% to 15% with respect to weight of the composition.

In some embodiments, the biostimulant composition comprises the protein-derived component in an amount ranging from about 0.01% to less than 20% with respect to weight of the composition.

In some embodiments, the biostimulant composition comprises the protein-derived component in an amount ranging from about 0.01% to 20% with respect to weight of the composition.

In some embodiments, the biostimulant composition comprises the protein-derived component in an amount ranging from about 0.01% to 25% with respect to weight of the composition.

In some embodiments, the biostimulant composition comprises the protein-derived component in an amount ranging from about 0.01% to less than 30% with respect to weight of the composition.

In some embodiments, the biostimulant composition comprises the protein-derived component in an amount ranging from about 0.01% to 30% with respect to weight of the composition.

In some embodiments, a liquid form of biostimulant composition according to the present disclosure comprises the protein-derived component in an amount of about 1 g/L to 300 g/L with respect to weight of the composition.

In some embodiments, a liquid form of biostimulant composition according to the present disclosure comprises the protein-derived component in an amount of about 1 g/L to 100 g/L with respect to weight of the composition.

In some embodiments, a solid form of biostimulant composition according to the present disclosure comprises the protein-derived component in an amount of about 1 g/kg to 300 g/kg with respect to weight of the composition.

In some embodiments, a solid form of biostimulant composition according to the present disclosure comprises the protein-derived component in an amount of about 1 g/kg to 100 g/kg with respect to weight of the composition.

Accordingly, in some embodiments, the biostimulant composition essentially consists of protein-derived component as a primary component.

In some embodiments, the protein-derived component is a protein molecule(s), a component derived from a protein molecule(s), or a combination thereof.

In some embodiments, the protein-derived component is obtained by hydrolysing a biomass comprising methanotrophic bacteria cells.

In some embodiments, the protein-derived component is obtained by hydrolysing a biomass of methanotrophic bacteria cells obtained by culturing the methanotrophic bacteria in a cell culture media. Accordingly, in some embodiments, the protein-derived component comprises a protein molecule(s) or a component derived from a protein molecule(s) produced by methanotrophic bacteria cells as a result of culturing them in a culture media. In some other embodiments, the protein-derived component comprises a component derived from cell culture broth. In still other embodiments, the protein-derived component comprises a component derived from cell culture broth, wherein said culture broth is obtained by culturing methanotrophic bacteria.

In some embodiments, the protein-derived component comprises proteins, peptides, amino acids, enzymes or hormones, or any combinations thereof.

In some embodiments, the amino acids comprised in the protein-derived component are in free form (free amino acids) or protein/peptide bound, or a combination of both free amino acids and protein/peptide bound amino acids. In some embodiments, the amino acids comprised in the protein-derived component are free amino acids.

In some embodiments, the hormones comprised in the protein-derived component is an amino acid-derived hormone, a peptide- or protein-derived hormone, or a combination thereof.

In some embodiments, the protein-derived component comprises proteins, peptides, amino acids, enzymes and hormones.

In some embodiments, the protein-derived component comprises varied amounts of proteins, peptides, amino acids, enzymes or hormones, or any combinations thereof. Particularly, since the protein-derived component is primarily obtained by hydrolysing methanotrophic bacteria cells, the amounts of proteins, peptides, amino acids, enzymes or hormones within the protein-derived component vary based on factors including but not limiting to the age of cells, environmental stimuli, cell growth conditions and C/H/N ratios.

In some embodiments, the protein-derived component comprises amino acids selected from the group comprising aspartic acid, glutamic acid, asparagine, glutamine, serine, threonine, tryptophan, tyrosine, phenyl alanine, methionine, lysine, leucine, proline, glycine, alanine, cysteine, arginine, valine, isoleucine, histidine, ornithine and combinations thereof.

In some embodiments, the protein-derived component comprises amino acids aspartic acid, glutamic acid, asparagine, glutamine, serine, threonine, tryptophan, tyrosine, phenyl alanine, methionine, lysine, leucine, proline, glycine, alanine, cysteine, arginine, valine, isoleucine, histidine and ornithine.

In some embodiments, the protein-derived component comprises at least one essential amino acid selected from lysine, threonine, methionine, tryptophan, histidine, valine, phenylalanine, isoleucine, leucine, proline and glycine.

In some embodiments, the protein-derived component comprises essential amino acids lysine, threonine, methionine, tryptophan, histidine, valine, phenylalanine, isoleucine, leucine, proline and glycine.

In some embodiments, essential amino acids play a primary and critical role within the amino acid fraction of the protein-derived component, wherein said essential amino acids can play different roles in plants such as stress-reducing agents, nitrogen source, hormone precursors, osmolytes, regulation of ion transport, modulating stomatal opening, maintaining redox homeostasis, plant metabolism, cell signaling. For example, proline is known to play as a role of an osmolyte. Tryptophan is known to play a role of a precursor for phytohormones. Lysine is known to play a role as a nitrogen source.

In some embodiments, the protein-derived component comprises essential amino acids in an amount of about 30% to 60%, including all values and ranges therefrom, with respect to weight of total amino acids in the protein-derived component, wherein said essential amino acids are lysine, threonine, methionine, tryptophan, histidine, valine, phenylalanine, isoleucine, leucine, proline and glycine.

In some embodiments, the protein-derived component comprises essential amino acids in an amount of about 40% to 60%, including all values and ranges therefrom, with respect to weight of total amino acids in the protein-derived component, wherein said essential amino acids are lysine, threonine, methionine, tryptophan, histidine, valine, phenylalanine, isoleucine, leucine, proline and glycine.

In some embodiments, the protein-derived component comprises non-essential amino acids in an amount of about 40% to 60%, including all values and ranges therefrom, with respect to weight of total amino acids in the protein-derived component, wherein said non-essential amino acids are aspartic acid, glutamic acid, serine, alanine, tyrosine and arginine.

In some embodiments, the protein-derived component comprises essential amino acids lysine in an amount of about 2% to 6%, threonine in an amount of about 2% to 3%, methionine in an amount of about 1% to 2%, tryptophan in an amount of about 0.1% to 1%, histidine in an amount of about 1% to 4%, valine in an amount of about 5% to 10%, phenylalanine in an amount of about 5% to 10%, isoleucine in an amount of about 5% to 10%, leucine in an amount of about 3% to 4%, proline in an amount of about 5% to 13% and glycine in an amount of about 1% to 8.5%, with respect to weight of total amino acids in the protein-derived component.

In some embodiments, the protein-derived component comprises lysine in an amount of about 4% to 6%, threonine in an amount of about 2% to 3%, methionine in an amount of about 1% to 2%, tryptophan in an amount of about 0.1% to 1%, histidine in an amount of about 2.5% to 4%, valine in an amount of about 7.5% to 10%, phenylalanine in an amount of about 5% to 7.5%, isoleucine in an amount of about 8% to 9%, leucine in an amount of about 3% to 4%, proline in an amount of about 10% to 13% and glycine in an amount of about 5% to 8.5%, with respect to weight of total amino acids in the protein-derived component.

In some embodiments, the protein-derived component comprises histidine in an amount of about 1% to 4%, valine in an amount of about 5% to 10%, isoleucine in an amount of about 5% to 10%, lysine in an amount of about 2% to 6% and proline in an amount of about 5% to 13%, with respect to weight of total amino acids in the protein-derived component.

In some embodiments, the protein-derived component comprises histidine in an amount of about 2.5% to 4%, valine in an amount of about 7.5% to 10%, isoleucine in an amount of about 8% to 9%, lysine in an amount of about 4% to 6% and proline in an amount of about 10% to 13%, with respect to weight of total amino acids in the protein-derived component.

In some embodiments, the protein-derived component comprises any combination of two or more essential amino acids selected from lysine, threonine, methionine, tryptophan, histidine, valine, phenylalanine, isoleucine, leucine, proline and glycine, at amounts (%) as defined above.

In some embodiments, the protein-derived component comprises peptides selected from polypeptides, oligopeptides and a combination thereof. In some embodiments, the protein-derived component comprises polypeptides. In some embodiments, the protein-derived component comprises oligopeptides. In some embodiments, the protein-derived component comprises a combination or mixture of polypeptides and oligopeptides.

In some embodiments, the oligopeptides are peptides consisting of two amino acids to forty amino acids. In some embodiments, the oligopeptides are peptides consisting of two amino acids, three amino acids, four amino acids, four amino acids, five amino acids, six amino acids, seven amino acids, eight amino acids, nine amino acids, ten amino acids, eleven amino acids, twelve amino acids, thirteen amino acids, fourteen amino acids, fifteen amino acids, sixteen amino acids, seventeen amino acids, eighteen amino acids, nineteen amino acids, twenty amino acids, twenty one amino acids, twenty two amino acids, twenty three amino acids, twenty four amino acids, twenty five amino acids, twenty six amino acids, twenty seven amino acids, twenty eight amino acids, twenty nine amino acids, thirty amino acids, thirty one amino acids, thirty two amino acids, thirty three amino acids, thirty four amino acids, thirty five amino acids, thirty six amino acids, thirty seven amino acids, thirty eight amino acids, thirty nine amino acids or forty amino acids.

In some embodiments, the protein-derived component comprises oligopeptides selected from the group comprising dipeptide, tripeptide, tetrapeptide, pentapeptide, hexapeptide, heptapeptide, octapeptide, nonapeptide, decapeptide, undecapeptide, dodecapeptides, icosapeptide, tricontapeptides and tetracontapeptides.

In some embodiments, the protein-derived component comprises any combination of at least two oligopeptides selected from dipeptide, tripeptide, tetrapeptide, pentapeptide, hexapeptide, heptapeptide, octapeptide, nonapeptide, decapeptide, undecapeptide, dodecapeptides, icosapeptide, tricontapeptides and tetracontapeptides.

In some embodiments, the protein-derived component comprises peptides having a size greater than 45 kDa (kilodaltons) in an amount of less than 5%, with respect to amount or distribution of total peptides in the protein-derived component.

In some embodiments, the protein-derived component comprises peptides having a size greater than 45 kDa in an amount of about 0.001% to 5% including all values or ranges therefrom, with respect to amount or distribution of total peptides in the protein-derived component. In some embodiments, the protein-derived component comprises peptides having a size greater than 45 kDa in an amount of about 0.001%, 0.01%, 0.1%, 1%, 1.5%, 2%, 2.5%, 3%, 3.5%, 4%, 4.5% or 5%, with respect to amount or distribution of total peptides in the protein-derived component.

In some embodiments, the protein-derived component comprises peptides having a size of about 17 kDa to 45 kDa in an amount of less than 5%, with respect to amount or distribution of total peptides in the protein-derived component.

In some embodiments, the protein-derived component comprises peptides having a size of about 17 kDa to 45 kDa in an amount of about 0.001% to 5% including all values or ranges therefrom, with respect to amount or distribution of total peptides in the protein-derived component. In some embodiments, the protein-derived component comprises peptides having a size of about 17 kDa to 45 kDa in an amount of about 0.001%, 0.01%, 0.1%, 1%, 1.5%, 2%, 2.5%, 3%, 3.5%, 4%, 4.5% or 5%, with respect to amount or distribution of total peptides in the protein-derived component.

In some embodiments, the protein-derived component comprises peptides having a size of about 1 kDa to 15 kDa in an amount of less than 20%, with respect to amount or distribution of total peptides in the protein-derived component.

In some embodiments, the protein-derived component comprises peptides having a size of about 1 kDa to 15 kDa in an amount of about 1% to 20% including all values or ranges therefrom, with respect to amount or distribution of total peptides in the protein-derived component. In some embodiments, the protein-derived component comprises peptides having a size of about 1 kDa to 15 kDa in an amount of about 5% to 20% including all values or ranges therefrom, with respect to amount or distribution of total peptides in the protein-derived component. In some embodiments, the protein-derived component comprises peptides having a size of about 1 kDa to 15 kDa in an amount of about 5%, 6%, 7%, 8%, 9%, 10%, 11%, 12%, 13%, 14%, 15%, 16%, 17%, 18%, 19% or 20%, with respect to amount or distribution of total peptides in the protein-derived component.

In some embodiments, the protein-derived component comprises peptides having a size lower than 1 kDa in an amount of more than 50%, with respect to amount or distribution of total peptides in the protein-derived component.

In some embodiments, the protein-derived component comprises peptides having a size lower than 1 kDa in an amount of about 50% to 90% including all values or ranges therefrom, with respect to amount or distribution of total peptides in the protein-derived component. In some embodiments, the protein-derived component comprises peptides having a size lower than 1 kDa in an amount of about 50%, 55%, 60%, 65%, 70%, 75%, 80%, 85% or 90%, with respect to amount or distribution of total peptides in the protein-derived component.

In some embodiments, the protein-derived component comprises peptides having a size greater than 45 kDa in an amount of less than 5%, peptides having a size of about 17 kDa to 45 kDa in an amount of less than 5%, peptides having a size of about 1 kDa to 15 kDa in an amount of less than 20%, and peptides having a size lower than 1 kDa in an amount of more than 50%, with respect to amount or distribution of total peptides in the protein-derived component.

In some embodiments, the protein-derived component comprises peptides having a size greater than 45 kDa in an amount of about 0.001% to 5%, peptides having a size of about 17 kDa to 45 kDa in an amount of about 0.001% to 5%, peptides having a size of about 1 kDa to 15 kDa in an amount of about 5% to 20%, and peptides having a size lower than 1 kDa in an amount of about 50% to 90%, with respect to amount or distribution of total peptides in the protein-derived component.

In some embodiments, the protein-derived component comprises peptides having a size of about 1 kDa to 15 kDa in an amount of about 5% to 20% and peptides having a size lower than 1 kDa in an amount of about 50% to 90%, with respect to amount or distribution of total peptides in the protein-derived component.

In some embodiments, the protein-derived component comprises peptides having a size greater than 45 kDa in an amount of less than 5%, peptides having a size of about 17 kDa to 45 kDa in an amount of less than 5% and peptides having a size lower than 1 kDa in an amount of more than 50%, with respect to amount or distribution of total peptides in the protein-derived component.

In some embodiments, the protein-derived component comprises peptides having a size greater than 45 kDa in an amount of about 0.001% to 5%, peptides having a size of about 17 kDa to 45 kDa in an amount of about 0.001% to 5% and peptides having a size lower than 1 kDa in an amount of about 50% to 90%, with respect to amount or distribution of total peptides in the protein-derived component.

In some embodiments, the protein-derived component comprises peptides having a size between 25 kDa and 45 kDa in an amount of about 0.1% to 5%.

In some embodiments, the protein-derived component comprises peptides having a size greater than 45 kDa (kilodaltons) in an amount of about 0.001% to 5%, peptides having a size between 25 kDa and 45 kDa in an amount of about 0.1% to 5% and peptides having a size lower than 1 kDa in an amount of about 50% to 90%, with respect to amount or distribution of total peptides in the protein-derived component.

In some embodiments, the hydrolysate based biostimulant composition comprises micronutrients selected from the group comprising calcium, magnesium, boron, iron, sodium and combinations thereof.

In some embodiments, the hydrolysate based biostimulant composition comprises micronutrients viz. calcium at about 1% to 25%, magnesium at about 1% to 30%, boron at about 0.001% to 1%, iron at about 0.001% to 1% and sodium at about 1% to 20%, with respect to weight of total micronutrients in the composition.

In some embodiments, the hydrolysate based biostimulant composition comprises calcium at about 12% to 25%, magnesium at about 20% to 30%, boron at about 0.1% to 1%, iron at about 0.1% to 1%, and sodium at about 10% to 20%, with respect to weight of total micronutrients in the composition.

In some embodiments, the hydrolysate based biostimulant composition of the present disclosure comprises any combination of the following structural features provided in Table Z below. In Table Z, ‘X’ represents presence of the feature as part of the combination encompassed in each row. Accordingly, every single combination provided in Table Z represents a separate embodiment of the present disclosure. However, the present disclosure also envisages a merger or mixture of these embodiments to provide for further possible combinations. Thus, for the purposes of the present disclosure, each of the combinations that are derivable from Table Z below are envisaged to exist individually, all together or in different combinations within the ambit of the present disclosure.

TABLE Z
Hydrolysate based
Biostimulant composition

| comprising a protein- | Structural Feature | | | |
|---|---|---|---|---|
| derived component | Feature 1 | Feature 2 | Feature 3 | Feature 4 |
| Composition A | X | X | | |
| Composition B | X | X | X | |
| Composition C | X | X | | X |
| Composition C | X | X | X | X |
| Composition E | X | | X | |
| Composition F | X | | X | X |
| Composition G | X | | | X |
| Composition H | X | | | |

NOTE:
Feature 1: Protein-derived component present in an amount of about 30% or less, or about 0.01% to 30%, or about 0.01% to 20%, or about 0.01% to 10%, including all values and ranges therefrom, with respect to weight of the composition.
Feature 2: Protein-derived component comprises lysine in an amount of about 2% to 6%, threonine in an amount of about 2% to 3%, methionine in an amount of about 1% to 2%, tryptophan in an amount of about 0.1% to 1%, histidine in an amount of about 1% to 4%, valine in an amount of about 5% to 10%, phenylalanine in an amount of about 5% to 10%, isoleucine in an amount of about 5% to 10%, leucine in an amount of about 3% to 4%, proline in an amount of about 5% to 13% and glycine in an amount of about 1% to 8.5%, including all values and ranges therefrom, with respect to weight of total amino acids in the protein-derived component.
Feature 3: Protein-derived component comprises peptides having a size greater than 45 kDa (kilodaltons) in an amount of less than 5%, peptides having a size of about 17 kDa to 45 kDa in an amount of less than 5%, peptides having a size of about 1 kDa to 15 kDa in an amount of less than 20%, and peptides having a size lower than 1 kDa in an amount of more than 50%, including all values and ranges therefrom, with respect to amount or distribution of total peptides in the protein-derived component.
Feature 4: The hydrolysate based biostimulant composition comprises micronutrients: calcium at about 1% to 25%, magnesium at about 1% to 30%, boron at about 0.001% to 1%, iron at about 0.001% to 1% and sodium at about 1% to 20%, including all values and ranges therefrom, with respect to weight of total micronutrients in the composition.

In some embodiments, the methanotrophic bacterium is a gammaproteobacterial methanotroph.

In some embodiments, the gammaproteobacterial methanotroph is a type I or type X methanotroph.

In some embodiments, the gammaproteobacterial methanotroph is a type I or type X methanotroph belonging to genus selected from the group comprising Methylococcus, Methylomonas, Methylobacter, Methyloglobulus, Methylovulum, Methylomicrobium, Methylosarcina, Methylosphaera, Methyloprofundus, Methylosoma, Methylocucumis, Methyloparacoccus, Methylogaea, Methylomagnum, Methyloterricola, Methylohalobius, Methylomarinum, Methylomarinovum, Methylocaldum, Methylothermus, Crenothrix and combinations thereof.

In some embodiments, the gammaproteobacterial methanotroph is a type I or type X methanotroph selected from the group comprising Methylococcus sp, Methylomonas sp, Methylobacter sp, Methyloglobulus sp, Methylovulum sp, Methylomicrobium sp, Methylosarcina sp, Methylosphaera sp, Methyloprofundus sp, Methylosoma sp, Methylocucumis sp, Methyloparacoccus sp, Methylogaea sp, Methylomagnum sp, Methyloterricola sp, Methylohalobius sp, Methylomarinum sp, Methylomarinovum sp, Methylocaldum sp, Methylothermus sp, Crenothrix sp and combinations thereof.

In some embodiments, the gammaproteobacterial methanotroph is selected from the group comprising Methylococcus capsulatus, Methylococcus mobilis, Methylomicrobium kenyense, Methylomicrobium alcaliphilum Methylomicrobium alcaliphilum 20Z, Methylomicrobium buryatense 5G, Methylomicrobium buryatense 4G, Halomonas pantelleriensis, Methylomicrobium album, Methylomonas methanica, MB 126, Methylobacter tundripaludum, Methylovulum miyakonense, Methylomonas rubra, Methylomonas koyamae, Methylomonas methancia, Methylomonas denitrificans, Methylomonas paludis, Methylomonas lenta, Methylomarinum vadi, Methylococcus thermophilus, Methylobacter whittenburyi, Crenothrix polyspora, Clonothrix fusca, Methylobacter bovis, Methylomonas aurantiaca, Methylomonas fodinarum, Methylobacter vinelandii, Methylomicrobium japanense, Methylococcaceae bacterium, Methylocystis methanolicus, Methylocucumis oryzae, Methylogaea oryzae, Methylosarcina lacus, Methylosoma difficile and combinations thereof.

In some embodiments, the gammaproteobacterial methanotroph is selected from the group comprising Methylococcus capsulatus, Methylocucumis oryzae Methylogaea oryzae, Methylomicrobium alcaliphilum, Methylomicrobium alcaliphilum 20Z, Methylomicrobium buryatense 5G, Methylomicrobium buryatense 4G, Halomonas pantelleriensis, Methylobacter tundripaludum, Methylobacter whittenburyi, Methylobacter marinus, Methylobacter luteus Methylosarcina lacus, Methylosarcina fibrata, Methylotericola oryzae, Methylosoma difficile, Methylomonas methanica, Methylomonas denitrificans, Methylomonas koyamae, Methylomicrobium album, Methylomicrobium agile, Methylovulum miyakonense, Methylovulum psychorotolerans, Methylomagnum ishizawai Methylohalobius crimeensis, Crenothrix polyspora, Methyloprofundus sedimenti and combinations thereof.

In some embodiments, methanotrophic bacteria is Methylococcus capsulatus.

In some embodiments, methanotrophic bacteria is a wild-type or native Methylococcus capsulatus, recombinant Methylococcus capsulatus, or a combination thereof.

In some embodiments, the hydrolysate based biostimulant composition comprises protein-derived component along with at least one non-protein metabolite, at least one culture media component and optionally at least one agriculturally acceptable excipient.

In some embodiments, the hydrolysate based biostimulant composition comprises protein-derived component, non-protein metabolite and culture media component.

In some embodiments, the hydrolysate based biostimulant composition comprises protein-derived component, non-protein metabolite, culture media component and agriculturally acceptable excipient.

In some embodiments, the hydrolysate based biostimulant composition comprises protein-derived component in an amount of about 30% or less, non-protein metabolite in an amount of about 0.01% to 50% and culture media component in an amount of about 0.1% to 50%, including all values and ranges therefrom, by weight of the composition.

In some embodiments, the hydrolysate based biostimulant composition comprises protein-derived component in an amount of about 30% or less, non-protein metabolite in an amount of about 0.01% to 30%, culture media component in an amount of about 0.1% to 30% and agriculturally acceptable excipient in an amount of about 0.01% to about 90%, including all values and ranges therefrom, by weight of the composition.

In some embodiments of the present disclosure, the non-protein metabolite is a component that is an intermediate, precursor or end product of metabolism and that does not comprise a protein molecule(s) or a protein derivative(s). In some embodiments, the non-protein metabolite comprises a component derived from culture broth which is not a protein molecule(s) or a protein derivative(s). In some embodiments, the non-protein metabolite comprises a component derived from culture broth, wherein said culture broth is obtained by culturing methanotrophic bacteria. In some embodiments, the non-protein metabolite comprises a component produced by methanotrophic bacteria cells as a result of culturing them in a culture media, and said component not being a protein molecule(s) or a protein derivative(s). In some embodiments, the non-protein metabolite comprises a component produced due to metabolic reaction(s) in methanotrophic bacteria during culturing of said methanotrophic bacteria, and said component not being a protein molecule(s) or a protein derivative(s).

In some embodiments, the non-protein metabolite comprises a component selected from the group comprising but not limited to lipids, carbohydrates, sugars, nucleic acids, nucleotides, vitamins, organic acids, osmolytes, lipid-derived hormones, minerals and combinations thereof.

In some embodiments of the present disclosure, the culture media component comprises a component derived from cell culture media employed for culturing a methanotrophic bacteria. Accordingly, in some embodiments, the culture media component comprises a component not produced by the methanotrophic bacteria cells but is rather added as a part of the cell culture media during culturing of the methanotrophic bacteria cells. In some embodiments, the culture media component is a non-cellular component.

In some embodiments, the culture media component comprises a component selected from the group comprising but not limited to inorganic nutrient, minerals, ions, salts, buffers and combinations thereof.

In some embodiments, the ions are cations, anions, or a combination thereof.

In some embodiments, the cations are selected from the group comprising magnesium, calcium, sodium, potassium, boron, manganese, nickel, iron, copper, zinc, molybdenum, cobalt and combinations thereof.

In some embodiments, the anions are selected from the group comprising phosphates, chlorides, sulphates, nitrates, nitrites, borates and combinations thereof.

In some embodiments, the culture media component comprises salts selected from the group comprising sodium salt, calcium salt, potassium salt, magnesium salt, manganese salt, cobalt salt, zinc salt, copper salt, iron salt, boron salt, nickel salt, molybdenum salt and combinations thereof.

In some embodiments, the culture media component comprises salts selected from the group comprising sodium chloride, potassium nitrate, magnesium sulphate, calcium chloride, sodium molybdate, ferrous sulphate, zinc sulphate, cobalt chloride, boric acid salt, zinc chloride, manganese chloride, nickel chloride, copper sulphate, phosphates of sodium or potassium, molybdate of sodium and combinations thereof.

In some embodiments, the salts are chelated salts, wherein the salts are attached to a chelating agent.

In some embodiments, the chelating agent is selected from the group comprising ethylenediaminetetraacetic acid (EDTA), citric acid, hydroxyamino-polycarboxylic acid, diethylenetriamine pentaacetic acid, hydroxy ethylenediaminetriacetic acid, tetrakis hydroxymethyl phosphonium sulfate, nitrilotriacetic acid, L-glutamic acid, N, N-diacetic acid (GLDA) and combinations thereof.

In some embodiments, the culture media component comprises an inorganic nutrient which is a micronutrient.

In some embodiments, the culture media component comprises a minerals selected from the group comprising magnesium, calcium, boron, iron, sodium, potassium, manganese, nickel, copper, zinc, molybdenum, cobalt, phosphorous and combinations thereof.

In some embodiments, the culture media component comprises a micronutrient selected from the group comprising magnesium, calcium, boron, iron, sodium, potassium and combinations thereof.

In some embodiments, the culture media component comprises the micronutrients magnesium, calcium, boron, iron and sodium.

In some embodiments, the culture media component comprises the minerals such as phosphorous, potassium, magnesium, calcium, boron, iron and sodium.

In some embodiments, the culture media component comprises a component selected from the group comprising magnesium, calcium, sodium, potassium, boron, manganese, nickel, iron, copper, zinc, molybdenum, cobalt, phosphates, chlorides, sulphates, nitrates, nitrites, borates and combinations thereof.

In some embodiments, the culture media component comprises the components magnesium, calcium, sodium, potassium, boron, manganese, nickel, iron, copper, zinc, molybdenum, cobalt, phosphates, chlorides, sulphates, nitrates, nitrites and borates.

In embodiments of the present disclosure, the protein-derived component, the non-protein metabolite and the culture media component of the hydrolysate based biostimulant composition as described above is obtained by hydrolysing a culture broth or biomass comprising methanotrophic bacteria cells. In some embodiments, the protein-derived component, the non-protein metabolite and the culture media component is obtained by hydrolysing a culture broth or biomass of methanotrophic bacteria cells obtained by culturing the methanotrophic bacteria in a cell culture media. Accordingly, in some embodiments, the protein-derived component, the non-protein metabolite and the culture media component are obtained as a result of culturing/fermenting methanotrophic bacteria cells in a culture media, wherein the resulting culture broth or biomass is further hydrolysed to finally obtain the hydrolysate based biostimulant composition as described above.

As described above, the hydrolysate based biostimulant composition comprising protein derived components, non-protein metabolites and culture media components may further/optionally contain one or more agriculturally acceptable excipient to arrive at a composition fit for end-use applications.

In some embodiments, the agriculturally acceptable excipient comprises a component selected from the group comprising carrier, protectant, adjuvant, surfactant, stabilizer, preservative, diluent, suspending agent, dispersing agent, cosolvent and combinations thereof.

In some embodiments, the carrier is selected from the group comprising but not limited to lignite, bentonite, peat, vermiculite, charcoal, soil mixture, farm yard manure and combinations thereof.

In some embodiments, the protectant is selected from the group comprising but not limited to polyethylene glycol (PEG), glycerol, DMSO, polyvinyl alcohol, sodium alginate, gelatin, gellan, welan and combinations thereof.

In some embodiments, the adjuvant is selected from the group comprising but not limited to xanthan gum, carboxymethyl cellulose (CMC), gum arabic, polyvinylpyrrolidone (PVP) and combinations thereof.

In some embodiments, the surfactant is selected from the group comprising but not limited to a cationic surfactant, anionic surfactant, non-ionic surfactant, silicon-based surfactant and combinations thereof.

In some embodiments, the surfactant is selected from the group comprising but not limited to a natural surfactant, semi-synthetic surfactant, synthetic surfactant and combinations thereof.

In some embodiments, the surfactant is selected from the group comprising but not limited to polyethylene glycol (PEG), polyvinylpyrrolidone (PVP), gum arabic, sodium alginate, Silwet L-77, Tween 20, Tween 80, Triton X 100 and combinations thereof.

In some embodiment, the stabilizer or preservative is selected from the group comprising but not limited to potassium sorbate, sorbic acid, trehalose, sugars, mannitol, citric acid, polyglutamic acid, sodium benzoate and combinations thereof.

In some embodiments of the present disclosure, the diluent is selected from the group comprising ionic buffer-based diluent solution, saline solution, water and combinations thereof.

In some embodiments of the present disclosure, the hydrolysate based biostimulant composition comprises:

i) at least one of proteins, peptides, amino acids, enzymes and hormones as protein-derived component;

ii) at least one of lipids, carbohydrates, sugars, nucleic acids, nucleotides, vitamins, organic acids, osmolytes, lipid-based hormones and minerals as non-protein metabolite;

iii) at least one of inorganic nutrients, minerals, ions, salts and buffers as culture media component; and

iv) optionally, at least one of carrier, protectant, adjuvant, surfactant, stabilizer, preservative, diluent, suspending agent, dispersing agent and cosolvent as an agriculturally acceptable excipient.

In some embodiments of the present disclosure, the hydrolysate based biostimulant composition comprises:

i) at least one of proteins, peptides, amino acids, enzymes and hormones as protein-derived component, wherein said protein-derived component is in an amount of about 30% or less;

ii) at least one of lipids, carbohydrates, sugars, nucleic acids, nucleotides, vitamins, organic acids, osmolytes, lipid-based hormones and minerals as non-protein metabolite, wherein said non-protein metabolite is in an amount of about 0.01% to 50%; and iii) at least one of inorganic nutrients, minerals, ions, salts and buffers as culture media component, wherein said culture media component is in an amount of about 0.1% to 50%.

In some embodiments of the present disclosure, the hydrolysate based biostimulant composition comprises:

i) at least one of proteins, peptides, amino acids, enzymes and hormones as protein-derived component, wherein said protein-derived component is in an amount of about 30% or less;

ii) at least one of lipids, carbohydrates, sugars, nucleic acids, nucleotides, vitamins, organic acids, osmolytes, lipid-based hormones and minerals as non-protein metabolite, wherein said non-protein metabolite is in an amount of about 0.01% to 30%;

iii) at least one of inorganic nutrients, minerals, ions, salts and buffers as culture media component, wherein said culture media component is in an amount of about 0.1% to 30%; and

iv) at least one of carrier, protectant, adjuvant, surfactant, stabilizer, preservative, diluent, suspending agent, dispersing agent and cosolvent as an agriculturally acceptable excipient, wherein said agriculturally acceptable excipient is in an amount of about 0.01% to 90%.

In some embodiments of the present disclosure, the hydrolysate based biostimulant composition comprises:

i) proteins, peptides, free amino acids, enzymes, and amino acid or peptide/protein-derived hormones as protein-derived component;

ii) lipids, carbohydrates, sugars, nucleic acids, nucleotides, vitamins, organic acids, osmolytes, lipid-based hormones and minerals as non-protein metabolite;

iii) magnesium, calcium, sodium, potassium, boron, manganese, nickel, iron, copper, zinc, molybdenum, cobalt, phosphates, chlorides, sulphates, nitrates and nitrites as culture media component; and

iv) optionally, at least one of carrier, protectant, adjuvant, surfactant, stabilizer, preservative, diluent, suspending agent, dispersing agent and cosolvent as an agriculturally acceptable excipient.

In some embodiments of the present disclosure, the hydrolysate based biostimulant composition comprises:

i) proteins, peptides, amino acids, enzymes and hormones as protein-derived component, wherein said protein-derived component is in an amount of about 30% or less;

ii) lipids, carbohydrates, sugars, nucleic acids, nucleotides, vitamins, organic acids, osmolytes, lipid-based hormones and minerals as non-protein metabolite, wherein said non-protein metabolite is in an amount of about 0.01% to 50%; and

iii) magnesium, calcium, sodium, potassium, boron, manganese, nickel, iron, copper, zinc, molybdenum, cobalt, phosphates, chlorides, sulphates, nitrates and nitrites as culture media component, wherein said culture media component is in an amount of about 0.1% to 50%.

In some embodiments of the present disclosure, the hydrolysate based biostimulant composition comprises:

i) proteins, peptides, amino acids, enzymes and hormones as protein-derived component, wherein said protein-derived component is in an amount of about 30% or less;

ii) lipids, carbohydrates, sugars, nucleic acids, nucleotides, vitamins, organic acids, osmolytes, lipid-based hormones and minerals as non-protein metabolite, wherein said non-protein metabolite is in an amount of about 0.01% to 30%;

iii) magnesium, calcium, sodium, potassium, boron, manganese, nickel, iron, copper, zinc, molybdenum, cobalt, phosphates, chlorides, sulphates, nitrates and nitrites as culture media component, wherein said culture media component is in an amount of about 0.1% to 30%; and

iv) at least one of carrier, protectant, adjuvant, surfactant, stabilizer, preservative, diluent, suspending agent, dispersing agent and cosolvent as an agriculturally acceptable excipient, wherein said agriculturally acceptable excipient is in an amount of about 0.01% to 90%.

In some embodiments of the present disclosure, the hydrolysate based biostimulant composition comprises crude protein at a concentration ranging from about 0.25% to 30%, minerals and salts at a concentration ranging from about 0.1% to 10%, carbohydrates and lipids together at a concentration ranging from about 0.2% to 20%, by weight of the composition.

In some embodiments of the present disclosure, the hydrolysate based biostimulant composition comprises total carbon at a concentration ranging from about 0.01% to 40%, nitrogen at a concentration ranging from about 0.01% to 60%, phosphorus at a concentration ranging from about 0.001% to 10% and potassium at a concentration ranging from about 0.001% to 20%, by weight of the composition.

In some embodiments, the hydrolysate based biostimulant composition comprises total carbon at a concentration ranging from about 0.01% to 10%, nitrogen at a concentration ranging from about 0.01% to 15%, phosphorus at a concentration ranging from about 0.001% to 2% and potassium at a concentration ranging from about 0.001% to 1%, by weight of the composition.

In some embodiments of the present disclosure, the hydrolysate based biostimulant composition has a pH ranging between 4 to 8.

In some embodiments, the hydrolysate based biostimulant composition has a pH ranging between 5 to 7.

In some embodiments of the present disclosure, the hydrolysate based biostimulant composition described herein is in a solid form or a liquid form.

In some embodiments, the hydrolysate based biostimulant composition is in a liquid form or a solid form, selected from but not limited to liquid sprays, dust, granular, beads, soluble powder, wettable powder, pellet, microencapsulated, emulsifiable concentrate, capsular suspension, dry flowable form, liquid flowable, and the likes. While these forms provide examples of different ways in which the biostimulant composition of the present disclosure can be formulated, the activity of the composition is not dependent on or changes with the change in form. Hence, a person skilled in the art can employ the composition of the present disclosure in a form that suits their purpose the best.

In all embodiments of the present disclosure, the hydrolysate based biostimulant composition as described above comprising a protein-derived component in an amount of about 30% or less with respect to weight of the composition and wherein said protein-derived component is obtained from a methanotrophic bacterium, provides at least one of the following benefits:
improves or enhances performance of plant,
increases availability or efficient utilization of at least one of nitrogen, phosphorus and potassium by the plant, or
reduces need for external addition of at least one nutrient selected from nitrogen, phosphorus and potassium, either individually or as part of a fertilizer.

Thus, the present disclosure provides methanotrophic bacteria derived protein hydrolysate composition as plant biostimulant, as described above. More particularly, the present disclosure provides plant biostimulant composition or formulation derived from hydrolysing a culture broth or biomass comprising methanotrophic bacteria, said plant biostimulant composition comprising protein-derived component in an amount of 30% or less with respect to weight of the composition, along with non-protein metabolite, culture media component and optionally an agriculturally acceptable excipient.

### Application of the Biostimulant Composition

Since multiple benefits are associated with use of the biostimulant composition, the present disclosure accordingly relates to application of the biostimulant composition as described above, to a plant.

In some embodiments, the application of the biostimulant composition to a plant is through a method that comprises contacting or applying the biostimulant composition described above to the plant or a part thereof.

In some embodiments, the application of the biostimulant composition is by treating or contacting with or applying to the plant through: a) its soil or rhizosphere, and/or a) through aerial or non-aerial parts of the plant selected from the group comprising root, shoot, leaf, flower, anther, stigma, stamen, fruit, seed and combinations thereof.

In some embodiments, the application of the biostimulant composition or the associated method promotes or improves or enhances plant growth/performance.

In some embodiments, the application of the biostimulant composition or the associated method increases availability or efficient utilization of at least one nutrient selected from but not limited to nitrogen, phosphorus and potassium, by the plant.

In some embodiments, the application of the biostimulant composition or the associated method reduces the need for external addition of at least one nutrient selected from nitrogen, phosphorus and potassium, either individually or as part of a fertilizer.

In some embodiments, the biostimulant composition:
a. improves or enhances performance of plant,
b. increases availability or efficient utilization of at least one of nitrogen, phosphorus and potassium by the plant, and
c. reduces need for external addition of at least one nutrient selected from nitrogen, phosphorus and potassium, either individually or as part of a fertilizer.

In some embodiments, a method of treating plants to promote plant growth comprises:
obtaining the plant biostimulant composition as described above; and
contacting the plant or a part thereof, with said plant biostimulant composition, wherein said method promotes plant growth and/or performance.

In some embodiments according to a method of treating plants to promote plant growth, the yield is improved by about 1% to 500% relative to a method not employing the plant biostimulant composition described herein.

In some embodiments according to the method of treating plants to promote plant growth, the yield is improved by about 1% to 250% relative to a method not employing the plant biostimulant composition described herein.

In some embodiments according to the method of treating plants to promote plant growth, the yield is improved by about 1% to 100% relative to a method not employing the plant biostimulant composition described herein.

In some embodiments according to the method of treating plants to promote plant growth, the yield is improved by about 1% to 50% relative to a method not employing the plant biostimulant composition described herein.

In some embodiments according to the method of treating plants to promote plant growth, the yield is improved by about 1% to 10% relative to a method not employing the plant biostimulant composition described herein.

In some embodiments according to the method of treating plants to promote plant growth, the yield is improved by about 1% to 5% relative to a method not employing the plant biostimulant composition described herein.

In some embodiments according to the method of treating plants to promote plant growth, the yield is improved by about 1.5 folds to 10 folds relative to a method not employing the plant biostimulant composition described herein.

In some embodiments, the biostimulant composition is contacted or applied to a plant in an amount ranging from about 0.1 L/acre to 100 L/acre.

In some embodiments, the biostimulant composition is contacted or applied to a plant in an amount ranging from about 0.1 L/acre to 50 L/acre.

In some embodiments, the biostimulant composition is contacted or applied to a plant in an amount ranging from about 0.1 L/acre to 25 L/acre.

In some embodiments, the biostimulant composition is contacted or applied to a plant in an amount ranging from about 0.1 L/acre to 10 L/acre.

In some embodiments, the biostimulant composition is contacted or applied to a plant in an amount ranging from about 0.5 L/acre to 5 L/acre.

In some embodiments, the biostimulant composition is contacted or applied to a plant in an amount ranging from about 0.1 kg/acre to 50 kg/acre.

In some embodiments, the biostimulant composition is contacted or applied to a plant in an amount ranging from about 0.5 kg/acre to 5 kg/acre.

In some embodiments, the biostimulant composition is in a solid form or a liquid form, and is contacted with or applied to the plant at a concentration ranging from about 1 ml per litre to about 500 ml per litre of the liquid form or 1 gm per kilogram to about 500 gm per kilogram of the solid form.

In some embodiments, the biostimulant composition is in a solid form or a liquid form, and is contacted with or applied to the plant at a concentration ranging from about 1× to 100000× dilution of the solid or liquid form of the composition.

In some embodiments, the biostimulant composition as described above is contacted with or applied to an aerial part of the plant including leaf as a foliar application.

In some embodiments, the biostimulant composition as described above is contacted or applied to the plant through its soil or rhizosphere.

In some embodiments, the biostimulant composition as described above is contacted or applied to the plant as a seed composition comprising a seed of the plant that is inoculated or coated with the present biostimulant composition. In some embodiments, the biostimulant composition as described above is provided as a seed coating, seed treatment or seed dressing.

In some embodiments, the biostimulant composition as described above is contacted or applied to the plant through aerial or non-aerial parts of the plant selected from the group comprising root, shoot, leaf, flower, anther, stigma, stamen, fruit, seed and combinations thereof.

In some embodiments, the biostimulant composition is contacted with or applied to a plant through its soil or aerial/non-aerial parts of the plant as described above, as a single dose, or multiple doses.

In some embodiments, the biostimulant composition is contacted with or applied as described above, as a single dose, or multiple doses, wherein each subsequent dose is administered 1 to 100 days apart per crop cycle.

In some embodiments, the biostimulant composition is contacted with or applied as described above, as a single dose, or multiple doses, wherein each subsequent dose is administered 1 to 50 days apart per crop cycle.

In some embodiments, the biostimulant composition is contacted with or applied as described above, as a single dose, or multiple doses, wherein each subsequent dose is administered 1 to 30 days apart per crop cycle.

In some embodiments, the biostimulant composition is contacted with or applied as described above, as a single dose, or multiple doses, wherein each subsequent dose is administered 1 to 15 days apart per crop cycle.

In some embodiments, the biostimulant composition is contacted with or applied as described above, as a single dose, or multiple doses, wherein each subsequent dose is administered 1 to 7 days apart per crop cycle.

In some embodiments, the application of the biostimulant composition is unaffected or unchanged by the seed rate, planting date, harvest time and other standard/conventional agricultural management practices. Hence, for application of the said composition, a person skilled in the art can freely modulate the said practices depending on the plant or crop in question.

In some embodiments, the amount/dosage of the biostimulant composition that is to be applied to a plant ranges from about 1× to 100000× dilution of the solid form or liquid form of the composition. For instance, the prepared biostimulant composition of the disclosure can be diluted 1 time to 100000 times with water or other diluent (for liquid formulation) or soil (for solid formulation) before application on to the plant.

In some embodiments, the amount of the biostimulant composition that is to be applied to a plant is known to a person skilled in the art. The said amount therefore does not form a limiting feature of the present disclosure. The importance lies in the constituents, its ratios/amounts and source of the biostimulant composition, most importantly, the composition comprising a protein-derived component in an amount of about 30% or less with respect to weight of the composition and said composition being obtained by hydrolysing a biomass comprising methanotrophic bacteria. Depending on the plant, a person skilled in the art will find no difficulty in modulating the dosage of the present biostimulant composition that needs to be applied or provided to a plant, as long as the above criteria are met.

### Improving Plant Performance

As mentioned previously, when the hydrolysate based biostimulant composition of the present disclosure is applied on or contacted with a plant, it improves or enhances its performance.

Accordingly, the present disclosure provides use of the above-described hydrolysate based biostimulant composition for enhancing or improving plant performance or productivity.

In some embodiments, the plant performance is enhanced or improved by applying or contacting the plant with the hydrolysate based biostimulant composition as described above.

In some embodiments, the present disclosure provides hydrolysate based biostimulant composition comprising protein-derived component, non-protein metabolite, culture media component and optionally an agriculturally acceptable excipient for improving or enhancing plant performance.

In all embodiments of improving or enhancing plant performance, the features of hydrolysate based biostimulant composition are as described in one or more of the preceding embodiments.

In some embodiments, enhancement or improvement in agricultural productivity is measured as the differential increase in agricultural productivity (such as crop yield, productivity or other beneficial parameters) when agricultural production is carried out with and without using/applying the biostimulant compositions described herein.

In some embodiments, the plant to which the biostimulant composition of the present disclosure is applied, is selected from but not limited to an agricultural crop, horticultural crop, spices, plantation crop, or any combinations thereof.

In some embodiments, the agricultural crop is selected from a group comprising but not limited to cereals, millets, pulses/legumes, cash crops, oil yielding crops and combinations thereof.

In some embodiments, the horticultural crop is selected from a group comprising but not limited to vegetable crops, medicinal crops, aromatic crops, floricultural crops, fruit crops, spices, plantation crops and combinations thereof.

In some embodiments, the plant is selected from a group comprising but not limited to radish, spinach, coriander, chili, cluster bean, potato, French bean, field bean, tomato, lettuce, rice, Saffron, marigold, broccoli, soybean, capsicum, grapes, English cucumber, pomegranate, wheat, carrot, maize, faba bean, sunflower, pea, canola, barley, mint, corn, and combinations thereof.

In some embodiments, enhancing or improving plant performance includes but is not limited to having a stimulating/promoting effect on plant growth, biomass production, yield, photosynthetic activity, nutritional value, nutrient use efficiency, improvement in plant specific metabolites, or any combinations thereof. In an embodiment, enhancing or improving plant performance comprises having a stimulating/promoting effect on plant as measured by increase in production or number of below ground or aerial biomass such as root, shoot, leaf, flowers, stamens, stigma, anthers, fruits, seeds, increase in photosynthetic activity during control or adverse conditions, improvement in crop specific metabolites, improved efficiency with regard to availability, absorption and use of nutrients/minerals, reduced use of chemical fertilizers, or any combinations thereof.

In some embodiments, improving or enhancing plant performance comprises stimulating or promoting a quantitative or qualitative plant attribute selected from a group comprising biomass production, yield, photosynthetic activity, nutritional value and nutrient use efficiency, or any combination thereof.

In some embodiments, effect of the improved or enhanced plant performance is measured through one or more of:
increase in number, size or quality of below ground or aerial biomass selected from a group comprising root, shoot, leaf, flowers, anthers, stigma, stamens, fruits and seeds or any combination thereof,
increase in photosynthetic activity or chlorophyll content,
increase in protein, dietary fibre, β-carotene, essential oil content, plant specific metabolites, or any combination thereof,
efficient absorption or utilization of available or externally provided nutrients or minerals.

In some embodiments a person skilled in the art understands that the attributes and the ways in which they are measured as provided above does not constitute an exhaustive list, and are only an indication and are provided for exemplification Enhancement or improvement in any other plant performance attribute or parameter not explicitly captured herein, also falls under the purview of the present disclosure. The importance lies in the fact that a plant is able to grow or survive better when the hydrolysate based biostimulant of the present disclosure is provided or applied to it.

In some embodiments, the hydrolysate based biostimulant composition as described above is used for improving the yield and other parameters in cultivation practices selected from a group comprising but not limited to hydroponics, aeroponics, vertical farming, indoor gardening, lawns and combinations thereof.

The present disclosure particularly relates to a method of improving or enhancing plant performance, said method comprising contacting the plant with the hydrolysate based biostimulant composition as described above.

In some embodiments, the method of improving or enhancing plant performance comprises contacting the plant with the hydrolysate based biostimulant composition comprising protein-derived component, non-protein metabolite, culture media component and optionally an agriculturally acceptable excipient as described above.

In some embodiments, the method of improving or enhancing plant performance comprises contacting the plant with the hydrolysate based biostimulant composition comprising protein-derived component in an amount of about 30% or less, non-protein metabolite in an amount of about 0.01% to 50% and culture media component in an amount of about 0.1% to 50%, by weight of the composition, as described above, wherein the composition is obtained from a methanotrophic bacterium.

In some embodiments, the method of improving or enhancing plant performance comprises contacting the plant with the hydrolysate based biostimulant composition comprising protein-derived component in an amount of about 30% or less, non-protein metabolite in an amount of about 0.01% to 50% and culture media component in an amount of about 0.1% to 50%, by weight of the composition, as described above, wherein the composition is obtained by hydrolysing a biomass comprising Methylococcus capsulatus.

In some embodiments according to the method of improving or enhancing plant performance, the plant biostimulant composition as described above is contacted with or applied to an aerial part of the plant including leaf as a foliar application to improve plant performance.

In some embodiments according to the method of improving or enhancing plant performance, the plant biostimulant composition as described above is contacted or applied to soil or rhizosphere to improve plant performance.

In some embodiments according to the method of improving or enhancing plant performance, the plant biostimulant composition as described above is contacted or applied to a seed to improve plant performance. In some embodiments according to the method of improving or enhancing plant performance, the biostimulant composition as described above is contacted or applied to the plant as a seed composition comprising a seed of the plant that is inoculated or coated with the present biostimulant composition, to improve plant performance. In some embodiments according to the method of improving or enhancing plant performance, the biostimulant composition as described above is applied as a seed coating, seed treatment or seed dressing, to improve plant performance.

In some embodiments according to the method of improving or enhancing plant performance, the biostimulant composition as described above is contacted or applied to the plant through aerial or non-aerial parts of the plant selected from the group comprising root, shoot, leaf, flower, anther, stigma, stamen, fruit, seed and combinations thereof, to improve plant performance.

In some embodiments according to the method of improving or enhancing plant performance, the plant biostimulant composition as described above is contacted with or applied to the whole plant to improve plant performance.

In some embodiments according to the method of improving or enhancing plant performance, the plant biostimulant composition as described above is contacted with or applied to the plant or a part thereof through any known mode of application to improve plant performance.

In some embodiments according to the method of improving or enhancing plant performance, the yield is improved by about 1% to 500% relative to a method not employing the plant biostimulant composition described herein.

In some embodiments according to the method of improving or enhancing plant performance, the yield is improved by about 1% to 250% relative to a method not employing the plant biostimulant composition described herein.

In some embodiments according to the method of improving or enhancing plant performance, the yield is improved by about 1% to 100% relative to a method not employing the plant biostimulant composition described herein.

In some embodiments according to the method of improving or enhancing plant performance, the yield is improved by about 1% to 50% relative to a method not employing the plant biostimulant composition described herein.

In some embodiments according to the method of improving or enhancing plant performance, the yield is improved by about 1% to 10% relative to a method not employing the plant biostimulant composition described herein.

In some embodiments according to the method of improving or enhancing plant performance, the yield is improved by about 1% to 5% relative to a method not employing the plant biostimulant composition described herein.

In some embodiments according to the method of improving or enhancing plant performance, the yield is improved by about 1.5 folds to 10 folds relative to a method not employing the plant biostimulant composition described herein.

In some embodiments according to the method of improving or enhancing plant performance, the yield is improved by about 1.5 folds to 5 folds relative to a method not employing the plant biostimulant composition described herein.

In some embodiments, application of the biostimulant composition of the present disclosure to a plant results in an increase in biomass by at least about 12%, when compared to a plant where the said composition has not been applied.

In some embodiments, application of the biostimulant composition of the present disclosure to a plant results in an increase in biomass by about 12% to about 39%, when compared to a plant where the said composition has not been applied.

In some embodiments, application of the biostimulant composition of the present disclosure to a plant results in an increase in biomass by at least about 13% to about 26%, when compared to a plant where the said composition has not been applied, and instead a commercially available hydrolysate based biostimulant comprising protein component (organic fraction) in an amount greater than 30% has been applied.

In some embodiments, application of the biostimulant composition of the present disclosure to a plant results in an increase in its pod yield by at least about 15%, when compared to a plant where the said composition has not been applied.

In some embodiments, application of the biostimulant composition of the present disclosure to a plant results in an increase in its pod yield by about 15% to 23%, when compared to a plant where the said composition has not been applied.

In some embodiments, application of the biostimulant composition of the present disclosure to a plant results in an increase in its pod yield by at least about 6% to about 24%, when compared to a plant where the said composition has not been applied, and instead a commercially available hydrolysate based biostimulant comprising protein component (organic fraction) in an amount greater than 30% has been applied.

In some embodiments, application of the biostimulant composition of the present disclosure to a plant results in an increase in fruit yield by at least about 13% to about 31%, when compared to a plant where the said composition has not been applied.

In some embodiments, application of the biostimulant composition of the present disclosure to a plant results in an increase in root length by at least about 40%, when compared to a plant where the said composition has not been applied.

In some embodiments, application of the biostimulant composition of the present disclosure to a plant results in an increase in photosynthetic efficiency as measured by SPAD index by at least about 20%, when compared to a plant where the said composition has not been applied.

### Reduction in Need of External Nutrients and Fertilizers

The present disclosure further provides a method of reducing need of external addition of at least one nutrient or nutrient carrying fertilizer for growth or survival of a plant, said method comprising contacting or applying the hydrolysate based biostimulant composition as described above, to the plant.

In some embodiments, the nutrient is selected from a group comprising but not limited to nitrogen, phosphorus and potassium, or any combination thereof.

In some embodiments, the fertilizer is a chemical fertilizer.

In some embodiments, the method reduces the need of chemical or synthetic fertilizer.

In some embodiments, contacting or applying the biostimulant composition to the plant decreases the usual conventional amount of nitrogen containing fertilizer, phosphorous containing fertilizer, potassium containing fertilizer, micronutrients or any combination thereof, required for producing an improved yield of the plant.

In some embodiments, a person skilled in the art readily knows and understands the amount of said fertilizers conventionally employed during the normal course of agriculture. The biostimulant composition of the present disclosure reduces the need for such external addition of said fertilizers.

In some embodiments, contacting or applying the biostimulant composition to the plant decreases the amount of nitrogen containing fertilizer comprising glutamine, ammonia, ammonium, urea, sulphur coated urea, methylene urea, polymer coated urea, isobutylidene diurea, nitrate, nitrite, ammonium containing molecules, nitrate containing molecules or nitrite containing molecules, or any combinations thereof, required for producing an improved yield of the plant.

In some embodiments, contacting or applying the biostimulant composition to the plant decreases the amount of phosphorous containing fertilizer comprising but not limited to diammonium phosphate, monoammonium phosphate, single super phosphate, ammonium dihydrogen phosphate, ammonium phosphate, super phosphate, tricalcium phosphate or any combinations thereof as a source of phosphate.

In some embodiments, contacting or applying the composition to the plant decreases the amount of potassium containing fertilizer comprising but not limited to muriate of potash, sulphate of potash, potassium nitrate, sulfate potash magnesia, kainite or a combination thereof as a source of potassium.

In some embodiments, the method reduces need for external addition of at least one of nitrogen, phosphorus and potassium for growth or survival of the plant, by at least about 10% to about 100%, when compared to the need for addition of respective nitrogen, phosphorus and potassium in a plant not contacted with the biostimulant composition of the present disclosure.

In some embodiments, the method decreases the amount of chemical fertilizer required for growth of a plant by at least about 10% relative to a method not employing the biostimulant composition defined herein.

In some embodiments, the method decreases the amount of chemical fertilizer required for growth of a plant by at least about 10%, 20%, 30%, 40%, 50%, 60%, 70%, 80% or 90% relative to a method not employing the biostimulant composition defined herein.

In some embodiments, application of the hydrolysate based biostimulant composition of the present disclosure with 50% less amount of traditional NPK fertilizer to a plant results in an increase in biomass production by at least about 50%, when compared to a plant grown under the same conditions of 50% less NPK fertilizer and where the said composition has not been applied.

In some embodiments, application of the biostimulant composition of the present disclosure with 50% less amount of traditional NPK to a plant results in an increase in biomass production by at least about 30%, when compared to a plant grown in the regular 100% NPK and where the said composition has not been applied.

In some embodiments, the present disclosure provides a method of reducing need of external addition of at least one nutrient or nutrient carrying fertilizer for growth or survival of a plant, said method comprising contacting or applying the hydrolysate based biostimulant composition comprising a protein-derived component in an amount of about 30% or less with respect to weight of the composition, wherein said protein-derived component is obtained from a methanotrophic bacterium. In some embodiments, the hydrolysate based biostimulant composition is in a solid form or a liquid form, and additionally comprises non-protein metabolite, culture media component and optionally agriculturally acceptable excipient.

In some embodiments, the hydrolysate based biostimulant composition reduces the need for external addition of at least one nutrient selected from nitrogen, phosphorus and potassium, either individually or as part of a fertilizer, and simultaneously improves or enhances performance of the plant.

In some embodiments, the features of protein-derived component including but not limiting to amounts/concentrations, amino acid profile, peptide profile and micronutrient profile; non-protein metabolite, culture media component, agriculturally acceptable excipient, their amounts/concentrations, methanotrophic bacterium etc. are as described above which is incorporated herein and is entirely applicable to the method of reducing need of external addition of at least one nutrient or nutrient carrying fertilizer for growth or survival of a plant. Particularly, in all embodiments of the method for reducing need of external addition of at least one nutrient or nutrient carrying fertilizer for growth or survival of a plant, the hydrolysate based biostimulant composition employed is as described by any of the embodiments mentioned above. Similarly, the manner in which the said biostimulant composition is to be applied to a plant, is also as described by any of the embodiments above. For the sake of brevity, and avoiding repetition, each of those embodiments are not being reiterated here again. However, each of the said embodiments, completely fall within the purview of the method of reducing need of external addition of at least one nutrient or nutrient carrying fertilizer.

In some embodiments, the hydrolysate based biostimulants composition comprising protein-derived component, non-protein metabolite, culture media component and optionally agriculturally acceptable excipient as described above is capable of significantly reducing the use of chemical fertilizer and/or micronutrients inputs required for growth of a plant. While chemical fertilizers such as urea, murate of potash and diammonium phosphate provide only Nitrogen, Potassium and phosphorous (diammonium phosphate can provide both P and N), the present hydrolysate based biostimulant composition aid in efficient utilization of NPK (Nitrogen, Potassium and phosphorous) by plants in addition to providing complex growth promoting substances leading to overall growth and development of the plants. Thus, the present hydrolysate based biostimulant composition possess significant advantage over the conventionally used chemical fertilizer and/or micronutrients inputs for enhancing plant growth and agricultural productivity.

The present disclosure also relates to a method of maintaining soil fertility comprising planting a plant or a part thereof contacted or applied with the hydrolysate based biostimulant composition of the present disclosure.

In some embodiments according to the method of maintaining soil fertility, the method further comprises harvesting the said plant.

In some embodiments according to the method of maintaining soil fertility, the method comprises sowing seed contacted or applied with the biostimulant composition of the present disclosure.

In some embodiments according to the method of maintaining soil fertility, the method maintains nitrogen levels of the soil and reduces the need of fertilizer required for plant growth, preferably nitrogen containing fertilizer.

In some embodiments according to the method of maintaining soil fertility, the method reduces the need of nitrogen containing fertilizer, phosphorous containing fertilizer, potassium containing fertilizer, micronutrients or any combination thereof.

While the preceding embodiments highlighted the importance of the biostimulant composition of the present disclosure, and how it impacts the performance of a plant, the following embodiments now provide a process for preparing the said hydrolysate based composition.

### Preparing the Biostimulant Composition

As discussed previously, the hydrolysate based biostimulant composition of the present disclosure is prepared by hydrolysing a composition or culture broth or a biomass comprising methanotrophic bacteria whole cells.

The present disclosure thus relates to a process of preparing the hydrolysate based biostimulant composition as described above is provided, said process comprising hydrolysing a biomass comprising methanotrophic bacteria cells and optionally adding agriculturally acceptable excipient, to obtain the hydrolysate based biostimulant composition.

In some embodiments of the process, a composition or culture broth or biomass comprising methanotroph whole cells is hydrolysed to obtain the hydrolysate based biostimulant composition comprising protein-derived component, non-protein metabolite and culture media component. In some embodiments, said composition or culture broth or biomass comprising methanotrophic bacteria whole cells is obtained by culturing said methanotrophic bacteria in a cell culture media. In some embodiments, said biostimulant is a methanotrophic bacteria derived protein hydrolysate as described above.

In some embodiments of the process, a composition or culture broth or biomass comprising methanotroph whole cells is hydrolysed to obtain the hydrolysate based biostimulant comprising protein-derived component in an amount of about 30% or less, non-protein metabolite in an amount of about 0.01% to 50% and culture media component in an amount of about 0.1% to 50%, by weight of the composition.

In some embodiments of the process, a composition or culture broth or biomass comprising methanotroph whole cells is hydrolysed to obtain a hydrolysate comprising protein-derived component, non-protein metabolite and culture media component, followed by addition of agriculturally acceptable excipient, to obtain the biostimulant composition.

In some embodiments of the process, a composition or culture broth or biomass comprising methanotroph whole cells is hydrolysed followed by addition of agriculturally acceptable excipient to obtain the hydrolysate based biostimulant comprising protein-derived component in an amount of about 30% or less, non-protein metabolite in an amount of about 0.01% to 30%, culture media component in an amount of about 0.1% to 30% and agriculturally acceptable excipient in an amount of about 0.01% to 90%, by weight of the composition.

In some embodiments, the process of preparing the hydrolysate based composition comprises hydrolysing a biomass using methods well-known in the art such as physical, mechanical methods or non-mechanical methods.

In some embodiments, hydrolysing of biomass comprising methanotrophic bacteria cells is carried out by a method selected from physical method, mechanical method, chemical method, enzymatic method, or any combination thereof.

In some embodiments, the physical method of hydrolysis includes subjecting to high temperature or heating, low temperature or freezing, subjecting to high pressure, microwave assisted hydrolysis, or any other physical methods.

In some embodiments, the non-mechanical method of hydrolysis includes chemical method such as pH dependent method; enzymatic method; or any other non-mechanical methods of hydrolysis.

In some embodiments of the process of preparing the biostimulant composition, the hydrolysing of biomass or composition comprising methanotrophic bacteria cells generates soluble fraction and insoluble fraction, wherein the soluble fraction can be separated from the insoluble fraction by separation methods known in the art such as filtration, centrifugation, decantation or any combinations thereof.

In some embodiments, the biomass or composition or culture broth comprising methanotrophic bacteria cells further comprises cellular metabolites and media-derived components. Accordingly, in some embodiments of the process of preparing the hydrolysate based biostimulant composition, the process comprises hydrolysing a biomass or composition comprising methanotrophic bacteria cells, cellular metabolites and media-derived components to obtain the hydrolysate based biostimulant composition. In some embodiments of the process of preparing the hydrolysate based biostimulant composition, the process comprises hydrolysing a biomass or composition comprising methanotrophic bacteria cells, cellular metabolites and media-derived components, followed by adding agriculturally acceptable excipient, to obtain the hydrolysate based biostimulant composition.

In some embodiments, the biomass comprising methanotrophic bacteria cells is subjected to steps of:
a) hydrolyzing the biomass comprising methanotrophic bacteria cells; and
b) optionally adding agriculturally acceptable excipient, to prepare the hydrolysate based biostimulant composition.

In some embodiments, a composition comprising methanotrophic bacteria cells, cellular metabolites and media-derived components is processed by steps comprising:
a) hydrolyzing the composition comprising methanotrophic bacteria cells, cellular metabolites and media-derived components; and
b) optionally adding agriculturally acceptable excipient, to obtain the hydrolysate based biostimulant composition.

In some embodiments, the process of preparing the hydrolysate based biostimulant composition comprises:
a) hydrolysing the biomass comprising methanotrophic bacteria cells by a method selected from physical method, mechanical method, chemical method, enzymatic method, or any combination thereof to obtain a hydrolysate comprising soluble and non-soluble fractions,
   wherein the biomass comprising methanotrophic bacteria cells is obtained by culturing the methanotrophic bacteria in a cell culture media;
b) separating the soluble and non-soluble fractions;
c) processing the soluble fraction of the hydrolysate; and
d) optionally adding agriculturally acceptable excipient, to obtain the hydrolysate based biostimulant composition.

In some embodiments, the methanotrophic bacterium is a gammaproteobacterial methanotroph (type I/type X).

In some embodiments, the methanotrophic bacterium is selected from different groups under gammaproteobacterial methanotroph (type I/type X class) based on the pathways used for assimilation of formaldehyde.

In some embodiments, the gammaproteobacterial methanotroph is a type I or type X methanotroph belonging to genus selected from the group comprising Methylococcus, Methylomonas, Methylobacter, Methyloglobulus, Methylovulum, Methylomicrobium, Methylosarcina, Methylosphaera, Methyloprofundus, Methylosoma, Methylocucumis, Methyloparacoccus, Methylogaea, Methylomagnum, Methyloterricola, Methylohalobius, Methylomarinum, Methylomarinovum, Methylocaldum, Methylothermus, Crenothrix and combinations thereof.

In some embodiments, the methanotrophic bacteria is Methylococcus capsulatus.

In some embodiments, the methanotrophic bacteria is selected from the group comprising Methylococcus capsulatus, Methylococcus mobilis, Methylomicrobium kenyense, Methylomicrobium alcaliphilum, Methylomicrobium alcaliphilum 20Z, Methylomicrobium buryatense 5G, Methylomicrobium buryatense 4G, Halomonas pantelleriensis, Methylomicrobium album, Methylomonas methanica, MB 126, Methylobacter tundripaludum, Methylovulum miyakonense, Methylomonas rubra, Methylomonas koyamae, Methylomonas methancia, Methylomonas denitrificans, Methylomonas paludis, Methylomonas lenta, Methylomarinum vadi, Methylococcus thermophilus, Methylobacter whittenburyi, Crenothrix polyspora, Clonothrix fusca, Methylobacter bovis, Methylomonas aurantiaca, Methylomonas fodinarum, Methylobacter vinelandii, Methylomicrobium japanense, Methylococcaceae bacterium, Methylocystis methanolicus, Methylocucumis oryzae, Methylogaea oryzae, Methylosarcina lacus, Methylosoma difficile and combinations thereof.

In some embodiments, the methanotrophic bacteria is selected from the group comprising Methylococcus capsulatus, Methylocucumis oryzae Methylogaea oryzae, Methylomicrobium alcaliphilum Methylomicrobium alcaliphilum 20Z, Methylomicrobium buryatense 5G, Methylomicrobium buryatense 4G, Halomonas pantelleriensis, Methylobacter tundripaludum, Methylobacter whittenburyi, Methylobacter marinus, Methylobacter luteus Methylosarcina lacus, Methylosarcina fibrata, Methylotericola oryzae, Methylosoma difficile, Methylomonas methanica, Methylomonas denitrificans, Methylomonas koyamae, Methylomicrobium album, Methylomicrobium agile, Methylovulum miyakonense, Methylovulum psychorotolerans, Methylomagnum ishizawai Methylohalobius crimeensis, Crenothrix polyspora, Methyloprofundus sedimenti, and combinations thereof.

In some embodiments, a biomass comprising Methylococcus capsulatus cells is hydrolysed to obtain the hydrolysate based biostimulant composition.

In some embodiments, a composition comprising Methylococcus capsulatus cells, cellular metabolites and media-derived components is hydrolysed to obtain the hydrolysate based biostimulant composition.

In some embodiments, the process of preparing the hydrolysate based biostimulant composition comprises:
a) hydrolysing a biomass of Methylococcus capsulatus by physical method, mechanical method, chemical method, enzymatic method, or any combination thereof to obtain a hydrolysate comprising soluble and non-soluble fractions, wherein the biomass of methanotrophic bacteria cells is obtained by culturing Methylococcus capsulatus in a cell culture media,
b) separating the soluble and non-soluble fractions,
c) processing the soluble fraction of the hydrolysate, and
d) optionally adding an agriculturally acceptable excipient, to obtain the hydrolysate based biostimulant composition.

In some embodiments of the present disclosure, culturing of the methanotrophs is carried out according to the description and examples of applications PCT/IB2017/052688 (publication no. WO2017195103) and/or PCT/IB2019/059664 (publication no. WO2020095281), which are incorporated herein in its entirety.

In some embodiments of the present disclosure, culturing of the Methylococcus capsulatus is carried out according to PCT/IB2017/052688 (publication no. WO2017195103) and/or PCT/IB2019/059664 (publication no. WO2020095281), which is incorporated herein in its entirety. In some embodiments of the present disclosure, culturing of the Methylococcus capsulatus in a cell culture media in presence of methane under suitable culturing conditions is described in PCT/IB2017/052688 (publication no. WO2017195103) and/or PCT/IB2019/059664 (publication no. WO2020095281), which is incorporated herein in its entirety.

A person skilled in the art will understand that the sequence of steps and the process for culturing and harvesting of methanotrophic bacteria cells is routine in the art, and can hence be carried out by any known technique. The importance lies in the fact that the final hydrolysate biostimulant composition so prepared must fulfil the following:
comprises a protein-derived component in an amount of about 30% or less with respect to weight of the composition, wherein said protein-derived component is obtained from a methanotrophic bacterium;
optionally comprises non-protein metabolite in an amount of about 0.01% to 50%;
optionally comprises culture media component in an amount of about 0.1% to 50%; and
optionally comprises agriculturally acceptable excipient in an amount of about 0.01% to about 90%.

### Combination Products

In some embodiments of the present disclosure, hydrolysate based biostimulant composition comprising protein derived component, non-protein metabolite, culture media component, and optionally an agriculturally acceptable excipient, can be combined with a methanotroph based composition comprising methanotroph whole cells or other microbial cell based biostimulants known in the art.

Accordingly, in some embodiments of the present disclosure, a biostimulant product is provided comprising:

a) the hydrolysate based biostimulant composition as described above; and
b) a protein hydrolysate composition(s) such as those obtained by lysing of non-methanotroph microbial cells.

In some embodiments, said non-methanotroph microbial cell is a plant growth-promoting microbe (PGPM).

Additionally, in some embodiments of the present disclosure, a biostimulant product is provided comprising:

a) the hydrolysate based biostimulant composition as described above; and
b) a composition comprising a microbial consortium of whole cells, wherein at least 50% whole cells are methanotrophic bacteria cells.

In some embodiments of the present disclosure, a biostimulant product is provided comprising:

a) the hydrolysate based biostimulant composition comprising protein derived component, non-protein metabolite, culture media component and optionally an agriculturally acceptable excipient, as described above; and

b) a composition comprising a microbial consortium of whole cells, cellular metabolites and media-derived components, wherein at least 50% whole cells are methanotrophic bacteria cells.

In some embodiments, the above microbial consortium of said biostimulant product comprising a) and b), comprises less than 50% whole cells of a non-methanotroph or a plant growth-promoting microbe (PGPM).

In some embodiments, the PGPM is selected from a group comprising nitrogen fixing microbe, phosphate solubilizing microbe, mineral solubilizing microbe, phytohormone secreting microbe, organic acids secreting bacteria, plant beneficial microbe and combinations thereof.

In some embodiments, the plant growth-promoting microbe (PGPM) is a plant growth-promoting bacteria (PGPB), endophytic bacteria, endophytic fungi, epiphytic bacteria, epiphytic fungi, mycorrhizal fungi, vesicular-arbuscular mycorrhiza (VAM), or any combinations thereof.

In some embodiments, the plant growth-promoting bacteria (PGPB) is plant growth-promoting rhizobacteria (PGPR).

In some embodiments, the plant growth-promoting microbe (PGPM) is a bacteria selected from the group comprising nitrogen fixing bacteria, phosphate solubilizing bacteria, mineral solubilizing bacteria, phytohormone secreting bacteria, organic acid secreting bacteria, other plant beneficial bacteria, and combinations thereof.

In some embodiments, a hydrolysate based biostimulant composition is obtained by a process of hydrolysing a biomass comprising a microbial consortium of one or more methanotrophic bacteria and one or more plant growth-promoting microbe (PGPM), said process comprising:
a) hydrolysing the cells of microbial consortium by a cell disruption method selected from physical method, mechanical method, chemical method, enzymatic method, or any combination thereof to obtain a hydrolysate comprising soluble and non-soluble fractions,
b) separating the soluble and non-soluble fractions,
c) processing the soluble fraction of the hydrolysate, and
d) optionally adding agriculturally acceptable excipient, to obtain the hydrolysate based biostimulant composition.

As mentioned previously, the so prepared hydrolysate based biostimulant composition of the present disclosure is important from agricultural and environmental perspective as it fulfills multiple attributes, and simultaneously overcomes the challenges with respect to increased chemical fertilizer usage and low agricultural productivity.

### Uses of the Biostimulant Composition

Thus, the present disclosure also provides for use of the hydrolysate based biostimulant composition of the present disclosure, for:
improving or enhancing plant performance, or
increasing availability or efficient utilization of at least one of nitrogen, phosphorus and potassium by the plant, or
reducing need of external addition of at least one nutrient or nutrient carrying fertilizer for growth or survival of a plant, or
any combination thereof.

In some embodiments, improving or enhancing plant performance is characterized by at least one of the following:
stimulation or promotion of a quantitative or qualitative plant attribute selected from a group comprising biomass production, yield, photosynthetic activity, nutritional value and nutrient use efficiency, improvement in plant specific metabolites, or any combination thereof,
increase in number, size or quality of below ground or aerial biomass selected from a group comprising root, shoot, leaf, flowers, anthers, stigma, stamens, fruits and seeds, or any combination thereof,
increase in photosynthetic activity or chlorophyll content,
increase in protein, dietary fibre, β-carotene, essential oil content, plant specific metabolite, or any combination thereof, or
efficient absorption or use of available or externally provided nutrient selected from a group comprising nitrogen, phosphorus and potassium, or any combination thereof.

In some embodiments, the biostimulant composition is in a solid form or a liquid form, and is contacted or applied to the plant through its soil, or through aerial or non-aerial parts of the plant selected from a group comprising root, shoot, leaf, flower, anther, stigma, stamen, fruit and seed, or any combination thereof.

The present disclosure also provides use of the hydrolysate based biostimulant composition of the present disclosure in a method of making an agricultural or horticultural product, comprising:

a) contacting or applying the biostimulant composition of the present disclosure to a crop; and
b) harvesting the crop to obtain an agricultural or horticultural product.

In some embodiments, the agricultural or horticultural product is selected from the group comprising but not limited to food grain, vegetable, fruit, tuber, nut, cereals, grains, millets, pulses, oil yielding crops, floricultural crops, medicinal plants, aromatic plants, spices, plantation crops, grasses and combinations thereof.

In all embodiments of the method of use provided herein, the biostimulant composition employed is as described by any of the embodiments mentioned above. Similarly, the manner in which the said biostimulant composition is to be applied to a plant, is also as described by any of the embodiments above. For the sake of brevity, and avoiding repetition, each of those embodiments are not being reiterated here again. However, each of the said embodiments, completely fall within the purview of the said use.

Thus, the present disclosure generally aims at providing unique and alternate approaches for promoting overall plant growth and performance along with achieving reduction in application of chemical fertilizer-based inputs and increase in nitrogen, phosphorous and/or potassium availability to the plants, in an environment friendly/biological manner. To achieve the same, hydrolysate based biostimulant composition as described above is provided. Said hydrolysate based biostimulant composition can be utilized for agricultural applications including improving the performance of plants/crops to achieve an overall improvement in agricultural productivity. In particular, the present protein hydrolysate biostimulant of the present disclosure is advantageous over conventionally used chemical fertilizers (source of NPK) since said protein hydrolysate biostimulant additionally comprises complex mixture of different growth promoting substances that trigger multiple physiological responses in plants leading to the overall growth and development of plants.

Additional embodiments and features of the present disclosure will be apparent to one of ordinary skill in art based upon description provided herein. The embodiments herein provide various features and advantageous details thereof in the description. Descriptions of well-known/conventional methods and techniques are omitted so as to not unnecessarily obscure the embodiments herein. Further, the disclosure herein provides for examples illustrating the above described embodiments, and in order to illustrate the embodiments of the present disclosure certain aspects have been employed. The examples used herein for such illustration are intended merely to facilitate an understanding of ways in which the embodiments herein may be practiced and to further enable those of skill in the art to practice the embodiments herein. Accordingly, the following examples should not be construed as limiting the scope of the embodiments herein.

### EXAMPLES

### Materials Employed

The Methylococcus capsulatus strain used in the present experiments/examples has been deposited in accordance with the Budapest Treaty with the Microbial Type Culture Collection (MTCC) and Gene Bank (MTCC 25398). The geographical origin and source of the strain is UK, and upon procurement, the strain was maintained at String Bio Private Limited. Further, all plants/crops which were employed in the below experiments/examples only to validate the technical effects of the product of present disclosure (methanotroph derived protein hydrolysate composition). None of these plants/crops were employed in preparing/developing said hydrolysate product of present disclosure.

### Example 1

Preparation of Protein Hydrolysate Based Biostimulant Composition from Methanotrophic Bacteria

The following process was employed to prepare protein hydrolysate based biostimulant composition:

Methanotrophic bacterial cells (Methylococcus capsulatus) were subjected to culturing/fermentation under methane (via. biogas or natural gas) as the sole carbon source. The culture conditions and processes were followed according to Examples 1, 10, 11, 12, 13 or 14 described in application PCT/IB2017/052688 (publication no. WO2017195103) or Examples 1, 2, 3, 5, 6, 7, 8, 9 or 10 described in application PCT/IB2019/059664 (publication no. WO2020095281), which are incorporated herein in its entirety.

Post fermentation, the harvested M. capsulatus cell broth was concentrated to about 6.0-12.0% total solids using microfiltration process. The concentrated cell mass was subsequently subjected to cell disruption by homogenization. Post homogenization, the cell broth was acid hydrolysed at pH 3. The resulting slurry was filtered to separate the protein rich liquid permeate.

For hydrolysis, while acid hydrolysis was performed in this experiment/example, any cell hydrolysis method known in the art can be followed, for instance, hydrolysis either through acid, alkali or physical methods can be employed to achieve the hydrolysate. For acid hydrolysis, the pH can be dropped to a range between 1 to 4. For alkali hydrolysis, the pH can be adjusted to a range between 8 to 11. For physical hydrolysis, the cell mass can be subjected to higher temperature (>50° C.) or pressure (>5 psi).

The liquid permeate i.e. soluble fraction of the hydrolysate obtained after acid hydrolysis and filtration contained a protein rich phase (protein-derived component) together with non-protein metabolites and culture media derived components. The exact levels of protein-derived component along with levels and characteristics of amino acids and peptides in the liquid phase (hydrolysate) was measured using HPLC analysis (Example 2). The levels of micronutrients in the overall hydrolysate composition were also analyzed by Inductively coupled plasma-optical emission spectrometry (ICP-OES) and Ion Chromatography (IC) (Example 2). The liquid permeate (hydrolysate) was formulated with agriculturally acceptable excipient, Tween 20, at 2%. Some of the other excipients such as sorbic acid, sodium sorbate, potassium sorbate, sodium benzoate, glycerol and/or DMSO can also be evaluated and used along with/without Tween 20. Said excipients can be used at 0.5%, 1%, 2% or 5%, or at any concentrations conventionally known/used in the art.

### Example 2

### Purification and Analysis of Methanotroph Derived Protein Hydrolysate Composition

The methanotrophic bacteria (M. capsulatus) based hydrolysate composition prepared according to Example 1 was mixed well to produce uniform solution, followed by analysis to characterize the composition. The exact levels of amino acids and peptides in the composition was measured using HPLC analysis. The levels of micronutrients in the overall hydrolysate composition were analyzed by Inductively coupled plasma-optical emission spectrometry (ICP-OES) and Ion Chromatography (IC) (Example 2). Upon component analysis of the prepared hydrolysate under Example 1, the hydrolysate (without addition of agriculturally acceptable excipient) had the following composition (Table 1):

TABLE 1
Composition of hydrolysate based
biostimulant (liquid composition)

| | Protein-derived | Non-protein | Culture media |
|---|---|---|---|
| Component | component | metabolite | component |
| Amount (%) | 4% | 1% | 1% |

Note:
Aqueous diluent (water) makes up ~94% of the liquid composition

The amino acid profile of critical/essential amino acids in the protein-derived component of the protein hydrolysate composition is shown in Table 2.

TABLE 2
Amino acid profile (critical/essential amino acids)
in the protein-derived component of the protein
hydrolysate composition as determined by HPLC

| | | Amount/levels in % (relative |
|---|---|---|
| | | to the total amino acids in the |
| | | protein-derived component of the |
| Category | Amino acids | protein hydrolysate composition) |
| Critical/Essential | Lysine | 5.3 |
| Amino Acids | Threonine | 2.3 |
| | Methionine | 1.55 |
| | Tryptophan | 0.60 |
| | Histidine | 3.0 |
| | Valine | 8.30 |
| | Phenylalanine | 6.30 |
| | Isoleucine | 9.08 |
| | Leucine | 3.68 |
| | Proline | 12.50 |
| | Glycine | 7.55 |

Apart from the essential amino acids recited in Table 2, the remaining % of amino acids in the protein-derived component was formed by non-essential amino acids including aspartic acid, glutamic acid, serine, alanine, tyrosine and arginine.

The levels/distribution of peptides (oligopeptides and polypeptides) in the protein-derived component of the hydrolysate composition based on sizes was determined by HPLC. The peptide distribution based on size profile is shown in Table 3.

TABLE 3
Peptide profile (oligopeptides and polypeptides) in the protein-
derived component of the protein hydrolysate composition

| | | 17 kDa | 1 kDa | |
|---|---|---|---|---|
| Peptide | >45 kDa | to 45 kDa | to 15 kDa | <1 Kda |
| Amount/Distribution | 4% | 4% | 16% | 76% |
| in % (relative to the | | | | |
| total peptides in the | | | | |
| protein-derived | | | | |
| component of the | | | | |
| protein hydrolysate | | | | |
| composition) | | | | |

The amounts of micronutrients in the hydrolysate composition were determined by Inductively coupled plasma atomic emission spectroscopy. The micronutrients profile is shown in Table 4.

TABLE 4
Micronutrients profile of the protein hydrolysate composition

| Micronutrients | Calcium | Magnesium | Boron | Sodium | Iron |
|---|---|---|---|---|---|
| Amount (%) | 20% | 25% | 0.44% | 18% | 0.01-1% |
| relative to the | | | | | |
| total | | | | | |
| micronutrients | | | | | |
| in the protein | | | | | |
| hydrolysate | | | | | |
| composition | | | | | |

### Example 3

### Application of Methanotroph Derived Protein Hydrolysate Biostimulant Composition in Spinach

A field trial experiment following a Randomized Complete Block Design (RCBD) was designed to understand the effect of methanotroph derived protein hydrolysate biostimulant composition described in Example 2 on yield improvement in Spinach (Spinacia oleracea). The seed rate, planting date, harvest time and other standard management practices were based on the norms of local agricultural practice except the application of present methanotroph derived protein hydrolysate composition. Seeds were sown in field with recommended dose of nitrogen, phosphorous and potassium. The first spraying of the methanotroph derived protein hydrolysate formulation on the Spinach plants was carried out 15 days after sowing followed by another application after an interval of 10 days. The plants were treated with either soil or foliar application. Methanotroph derived protein hydrolysate composition at dose of about 5 ml/L was used for this study. The concentration of protein hydrolysate composition in the final formulation containing adjuvant (excipient) was about 4%. Water was used for both foliar and soil application to control plants. Plants were harvested 40-45 days after sowing. The aerial biomass was used to determine the yield improvement. All observations, unless or otherwise noted, were taken from uniform sampling of plants from all test conditions.

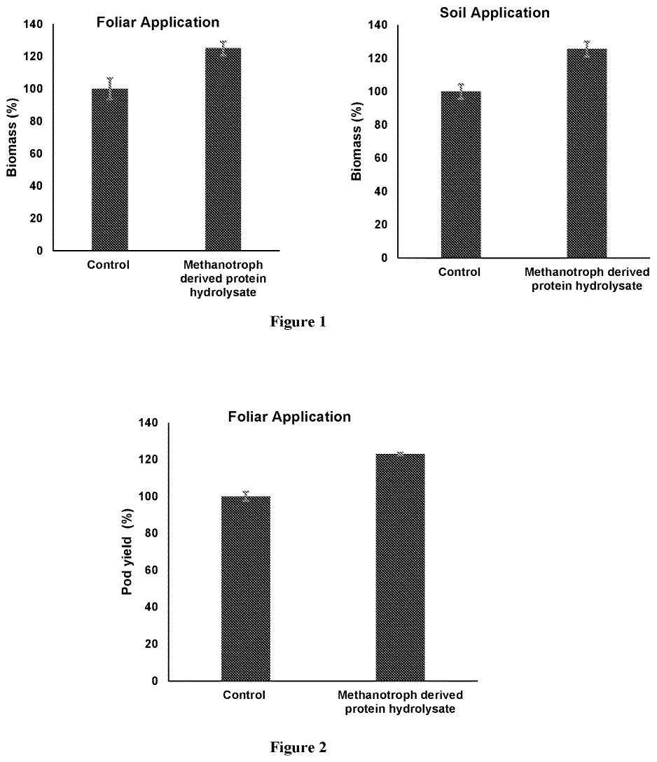

The results of the experiments are given in FIG. 1. As observed, foliar or soil application of methanotroph derived protein hydrolysate composition to Spinach showed significantly improved shoot biomass of ˜25% compared to control plants that received water spray. The described results on yield improvement in Spinach further validate the efficiency of the present methanotroph derived protein hydrolysate biostimulant composition to bring about agriculturally relevant results like yield improvement in open field conditions.

### Example 4

Application of Methanotroph Derived Protein Hydrolysate Biostimulant Composition in Cluster beans

A plot trial experiment was designed following a Randomized Complete Block Design (RCBD) to understand the effect of methanotroph derived protein hydrolysate biostimulant composition as described in Example 2 on pod yield in cluster bean (Cyamopsis tetragonoloba). The plant population, planting date, harvest time and other standard management practices were based on the norms of local agricultural practice except the application of present methanotroph derived protein hydrolysate composition. Seeds were sown in field with recommended dose of nitrogen, phosphorous and potassium. Thirty days after sowing (DAS), first foliar application of methanotroph derived protein hydrolysate biostimulant composition was performed. The second and third foliar applications were performed 45 and 60 DAS respectively. Methanotroph derived protein hydrolysate composition at a dose of about 3 ml/L was used for this study. The concentration of protein hydrolysate composition in the final formulation was about 5%. Water was sprayed to control plants. Pods harvested from multiple picking were measured to understand the total yield improvement. All observations, unless or otherwise noted, were taken from uniform sampling of plants.

The results of the experiments are given in FIG. 2. As observed, plants treated with methanotroph derived protein hydrolysate biostimulant composition showed significantly improved pod yield of ˜23% compared to control. The described results on yield improvement in cluster bean further validate the ability of methanotroph derived protein hydrolysate biostimulant composition to bring about agriculturally relevant results like pod yield improvement in open field conditions.

### Example 5

### Application of Methanotroph Derived Protein Hydrolysate Biostimulant Composition in Cereals and Horticultural Crops

The effect of methanotroph derived protein hydrolysate biostimulant composition as described in Example 2 on yield improvement in other agriculturally important crops like sweet corn, chili, coriander, field bean and marigold were evaluated (Table 5). The plant population, planting date, harvest time and other standard management practices were based on the norms of local agricultural practice except the application of methanotroph derived protein hydrolysate composition. Experiments were conducted at different locations in farmer's fields. The methanotroph derived protein hydrolysate composition at a dose of about 3 ml/L to 5 ml/L was used depending on the crops. The yield results demonstrate that the present methanotroph derived protein hydrolysate biostimulant show significant yield improvement ranging from about 12% to 56% in different crops compared to respective controls which were not subjected to the application of present biostimulant composition. Said results/improvement in yield additionally indicates the ability of present methanotroph derived protein hydrolysate biostimulant composition in enhancing/promoting plant growth or performance in diverse crop groups.

TABLE 5
Effect of present methanotroph derived protein hydrolysate
biostimulant composition on yield improvement in
different crops tested under field conditions

| | Yield improvement (%) | |
|---|---|---|
| | | Methanotroph derived protein |
| Crop | Control | hydrolysate based biostimulant |
| Sweet corn (Cobs) | 100 | 113-128 |
| Chilli (Fruits) | 100 | 113-131 |
| Coriander (Aerial biomass) | 100 | 112-139 |
| Field bean (Pods) | 100 | 115-122 |
| Marigold (Flower) | 100 | 150-156 |

### Example 6

### Effect on Nutrient Use Efficiency by Application of Methanotroph Derived Protein Hydrolysate Biostimulant Composition

A field trial experiment was designed following a Randomized Complete Block Design (RCBD) to understand the effect of methanotroph derived protein hydrolysate biostimulant composition as described in Example 2 to understand its effect on nutrient uptake in Spinach (Spinacia oleracea). The plant population, planting date, harvest time and other standard management practices were based on local agricultural practice except the application of methanotroph derived protein hydrolysate biostimulant composition. Seeds were sown in field with recommended dose of nitrogen, phosphorous and potassium. Fifteen days after sowing (DAS), first soil application of methanotroph derived protein hydrolysate composition along with an agriculturally acceptable excipient (adjuvant) was performed. The second soil application was performed twenty-five days post sowing. The concentration of protein hydrolysate in the final formulation containing adjuvant (excipient) was about 0.1-5%. Methanotroph derived protein hydrolysate composition at dose of about 5 ml/L was used for this study. Water with appropriate adjuvant was used for soil application in control plants. Levels of Nitrogen, Potassium and Phosphorous were analyzed to understand the effect of present methanotroph derived protein hydrolysate on plant nutrient uptake. Pooled samples were harvested from uniform sampling of the plants. Samples were dried before analyzing levels of Nitrogen, Potassium and Phosphorus following standard protocols.

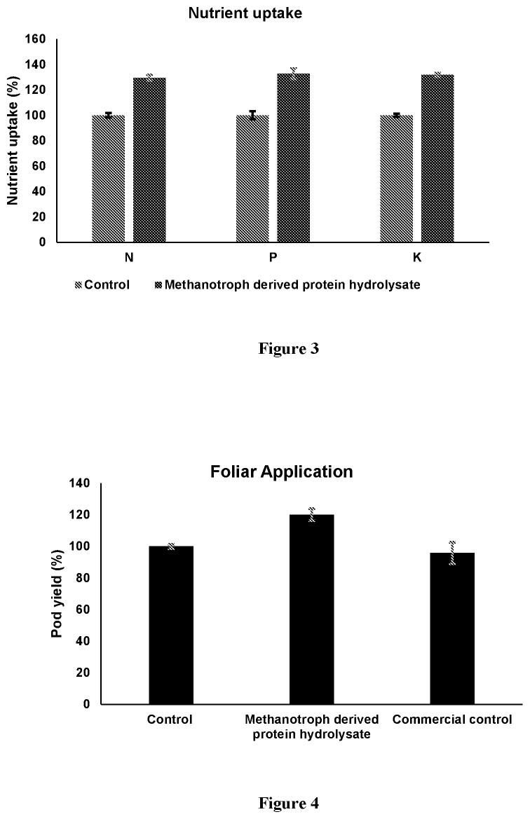

The results of the experiments are given in FIG. 3. As observed, plants treated with methanotroph derived protein hydrolysate biostimulant composition showed significantly improved uptake of Nitrogen (N), Phosphorous (P) and Potassium (K). Said results/improvement in nutrient uptake additionally demonstrates the ability of present methanotroph derived protein hydrolysate biostimulant composition in improving nutrient use efficiency in plants at field conditions by increasing the availability/uptake of nitrogen, phosphorous and potassium in plants, thus leading to a reduced fertilizer usage or the reduced need for external addition of nutrients (nitrogen, phosphorus and potassium).

### Example 7

### Comparison of Present Methanotroph Derived Protein Hydrolysate Biostimulant Composition and Commercial Control

A plot trial experiment was designed following a Randomized Complete Block Design (RCBD) to understand the effect of methanotroph derived protein hydrolysate biostimulant composition as described in Example 2 on pod yield in field bean (Viejo faba) and Bengal gram (Cicer arietinum), and biomass in coriander (Coriandrum sativum) over the protein hydrolysate product (commercial control) available in the market. The plant population, planting date, harvest time and other standard management practices were based on local agricultural practice except the application of methanotroph derived protein hydrolysate biostimulant and commercial control. Seeds were sown in field with recommended dose of nitrogen, phosphorous and potassium. For field bean, three foliar application was performed at 20 days after sowing (DAS), 40 DAS and 55 DAS. Foliar application at 30 DAS and 60 DAS was performed for Bengal gram. Two foliar application was performed for coriander at 20 DAS and 30 DAS. For Spinach, the treatment was same as mentioned in above Example 3. The concentration of protein hydrolysate in the final formulation containing adjuvant (excipient) was about 0.1-5%. Methanotroph derived protein hydrolysate composition at dose of about 5 ml/L was used for this study. Water with appropriate adjuvant was sprayed to negative control plants. A commercial protein hydrolysate biostimulant product was used as commercial check control [referred as ‘commercial control’ in FIGS. 4-7]. This commercial product contains about 62.5% protein component (amino acids and peptides) in its organic fraction and manufacturer's recommended dose was applied as foliar spray at appropriate time points. Pods harvested from multiple picking were measured to understand the total yield improvement in field bean. The plant biomass data was recorded in case of coriander. All observations, unless or otherwise noted, were taken from the plants that were at center of the plots and border plants were not considered for any of the observations.

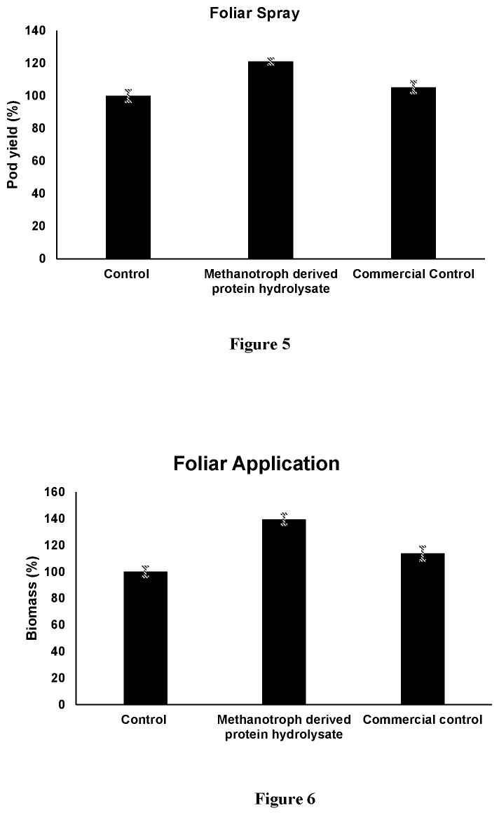

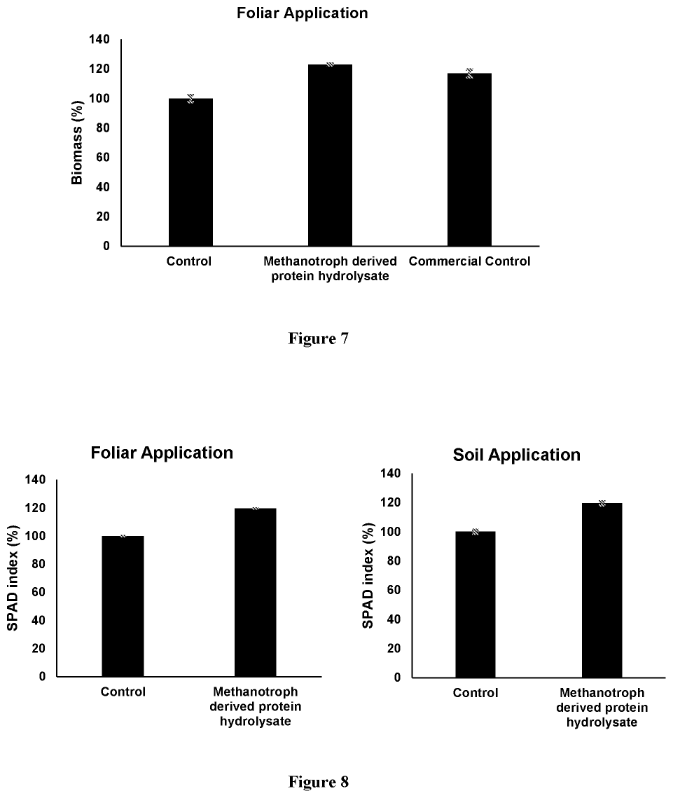

The results of the experiments are given in FIGS. 4, 5, 6, 7 and Table 6. As observed, plants treated with the present methanotroph derived protein hydrolysate composition showed significantly improved pod yield in field bean and Bengal gram (FIGS. 4 and 5), and biomass in coriander (FIG. 6) and Spinach (FIG. 7) compared to both commercial control and negative control. Particularly, application of present methanotrophic derived protein hydrolysate biostimulant resulted in ˜20% pod yield improvement, ˜15% pod yield improvement, ˜39% biomass improvement and ˜11% biomass improvement over commercial control in field bean, Bengal gram, coriander and spinach, respectively. Said results on yield improvement further validates the ability of the present methanotroph derived protein hydrolysate biostimulant to bring about agriculturally relevant results compared to commercial products available in market. Particularly, the comparative results indicate that the present hydrolysate product containing lower amount of protein component/protein-derived component (<30%) has significantly better effect in enhancing/improving plant performance vis-à-vis commercial protein hydrolysate product containing high protein content (about 62.5% protein component in its organic fraction). Additionally, a significant yield improvement by application of present composition vis-à-vis negative control is also evident from FIGS. 4-7 and Table 6.

TABLE 6
Effect of Methanotroph derived protein hydrolysate based biostimulant
composition on yield improvement over negative control and
commercial control tested under field conditions

| | Yield improvement in (%) | | |
|---|---|---|---|
| | | Methanotroph derived | |
| | | protein hydrolysate | Commercial |
| Crop | Control | based biostimulant | Control |
| Field bean (Pod | 100 ± 1.47 | 120 ± 3.79 | 96 ± 6.84 |
| yield) | | | |
| Bengal gram (Pod | 100 ± 3.50 | 121 ± 1.75 | 105 ± 3.50 |
| yield) | | | |
| Coriander (Aerial | 100 ± 3.81 | 139 ± 4.07 | 113 ± 5.08 |
| biomass) | | | |
| Spinach (Aerial | 100 ± 3.30 | 125 ± 5.25 | 112 ± 3.08 |
| biomass) | | | |

### Example 8

### Application of Present Methanotroph Derived Protein Hydrolysate Biostimulant Improves Chlorophyll Content and Photosynthetic Efficiency

A field trial experiment was designed to understand the effect of present methanotroph derived protein hydrolysate biostimulant described in Example 2 to understand the chlorophyll levels in Spinach (Spinacia oleracea). The growth conditions and application of methanotroph derived protein hydrolysate biostimulant was similar to Example 3. The employed control included water based formulation. Leaf chlorophyll was measured using SPAD meter.

The results of the experiments are given below in FIG. 8. As observed, plants treated with the present methanotroph derived protein hydrolysate biostimulant composition showed significantly improved SPAD index (an improvement of 19% over control under foliar application and an improvement of 19% over control under soil application) thus indicating better photosynthetic efficiency and produce quality.

### Example 9

### Application of Methanotroph Derived Protein Hydrolysate Based Biostimulant Improves Produce Quality (Dietary Fibre and Protein Content)

A field trial experiment was designed to understand the effect of methanotroph derived protein hydrolysate based biostimulant as described in Example 2 on improving dietary fibre and protein content in Spinach (Spinacia oleracea). The growth conditions and biostimulant application was similar to Example 3. Leaf dietary fibre and total protein were measured following standard protocols that has been reported previously.

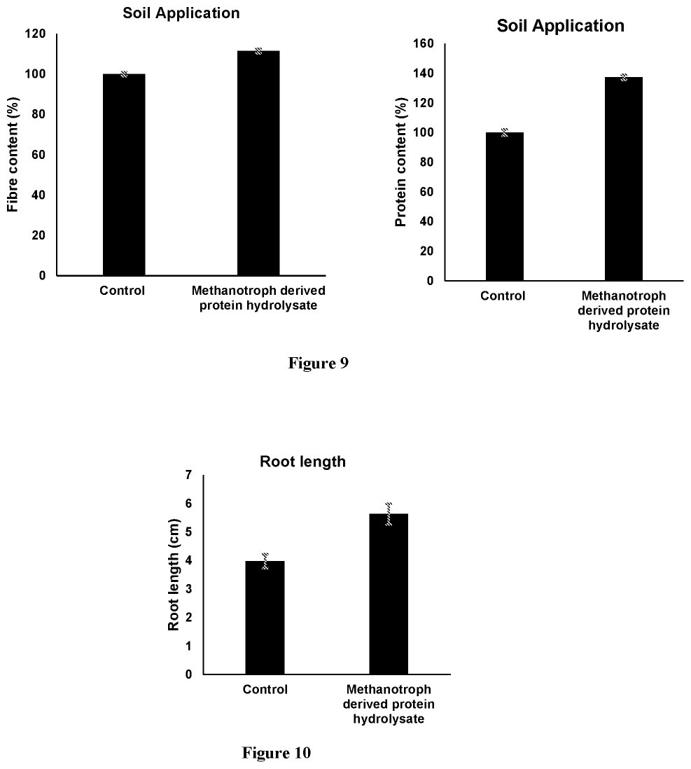

The results of the experiments are given in FIG. 9. As observed, plants treated with methanotroph derived protein hydrolysate based biostimulant showed significantly improved dietary fibre (˜11%) and protein (˜37%) over control plants, thus demonstrating better produce quality.

### Example 10

### Application of Methanotroph Derived Protein Hydrolysate Composition Improves Root Growth and Early Seedling Establishment in Paddy

To understand the ability of methanotroph derived protein hydrolysate composition in improving root growth and seedling establishment, the present experiment was performed. The methanotroph derived protein hydrolysate composition as described in Example 2 was used for this study, wherein the protein hydrolysate had a concentration of about 0.1-5% in the final biostimulant formulation containing adjuvant (excipient). Methanotroph derived protein hydrolysate composition at dose of about 3 ml/L was used for this study. Paddy seeds were soaked overnight in methanotroph derived protein hydrolysate composition and seeds were subsequently transferred to germination sheets or petri dishes containing moist filter paper. Control seeds were soaked in water. The effect of methanotroph derived protein hydrolysate composition on early seedling establishment by improving root growth was recorded. Twelve seeds from three different replicates were randomly sampled and were used for data recording.

The results from these experiments are given below in FIG. 10. As observed, seeds treated with methanotroph derived protein hydrolysate composition showed significant increase (˜40%) in root length compared to control seeds. Said results additionally indicates the ability of present methanotroph derived protein hydrolysate composition in helping early seedling establishment by modulating the growth of roots.

### Example 11

### Application of Methanotroph Derived Protein Hydrolysate Composition Improves Root and Shoot Biomass in Radish

To understand the ability of methanotroph derived protein hydrolysate composition in improving root and shoot biomass in Radish, the present experiment was performed. Raphanus sativus var. longipinnatus (Radish) seeds were grown in cocopeat and conventionally required amount of nitrogen, phosphorous and potassium was supplemented. At 20 days post germination, in separate experiments, foliar application of methanotroph derived protein hydrolysate composition containing an agriculturally acceptable excipient (adjuvant) was performed. The methanotroph derived protein hydrolysate composition as described in Example 2 was used for this study, wherein the protein hydrolysate had a concentration of about 0.5-5% in the final biostimulant formulation containing adjuvant (excipient). Methanotroph derived protein hydrolysate composition at dose of about 5 ml/L was used for this study. Water was used as control for both foliar and soil application. Plants were harvested 50 days after sowing. The plants were measured for biomass yield and other morphological characteristics.

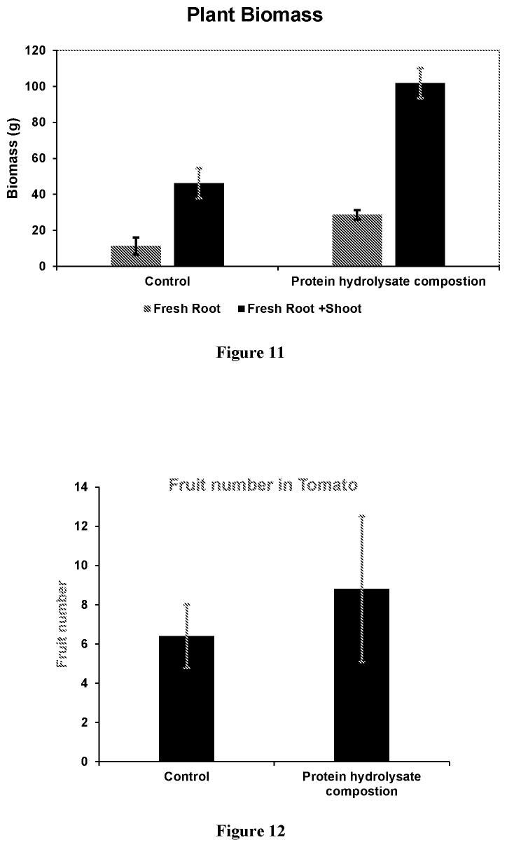

The results of the experiments are given below in FIG. 11. As observed, plants treated with methanotroph derived protein hydrolysate composition showed significantly improved root (2.5 fold) and shoot biomass (2.2 fold) compared to control. Said results/improvement in root and shoot biomass additionally indicates the ability of present methanotroph derived protein hydrolysate based biostimulant in enhancing/promoting plant growth or performance.

### Example 12

### Application of Methanotroph Derived Protein Hydrolysate Composition Increases Fruit Number in Tomato

To understand the ability of methanotroph derived protein hydrolysate composition in improving root and shoot biomass in Radish, the present experiment was performed. Ten days old tomato seedlings were transferred in cocopeat and conventionally required amount of nitrogen, phosphorous and potassium was supplemented. Ten days post transplantation, first foliar application of methanotroph derived protein hydrolysate composition containing an agriculturally acceptable excipient (adjuvant) was performed, and subsequently two more doses were given. The methanotroph derived protein hydrolysate composition as described in Example 2 was used for this study, wherein the protein hydrolysate had a concentration of about 0.5-5% in the final biostimulant formulation containing the adjuvant (excipient). Methanotroph derived protein hydrolysate composition at dose of about 5 ml/L was used for this study. Water was used as control for both foliar and soil application. The plants were measured for fruit number and other morphological characteristics post 60 days of transplantation.

The results of the experiments are given below in FIG. 12. As observed, plants treated with methanotroph derived protein hydrolysate based biostimulant showed a significantly greater number of ripe fruits (3.5 fold) compared to control. Said results/improvement indicates the ability of present methanotroph derived protein hydrolysate based biostimulant composition in enhancing/promoting plant growth/performance and fruit yield.

The foregoing description of the specific embodiments reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising” or “including” wherever used, will be understood to imply the inclusion of a stated element, integer or step, or group of elements, integers or steps, but not the exclusion of any other element, integer or step, or group of elements, integers or steps.

Throughout this specification, the term ‘combinations thereof’ or ‘any combination thereof’ or ‘any combinations thereof’ are used interchangeably and are intended to have the same meaning, as regularly known in the field of patents disclosures.

As used herein, the term “comprising” when placed before the recitation of steps in a method means that the method encompasses one or more steps that are additional to those expressly recited, and that the additional one or more steps may be performed before, between, and/or after the recited steps. For example, a method comprising steps a, b, and c encompasses a method of steps a, b, x, and c, a method of steps a, b, c, and x, as well as a method of steps x, a, b, and c. Furthermore, the term “comprising” when placed before the recitation of steps in a method does not (although it may) require sequential performance of the listed steps, unless the content clearly dictates otherwise. For example, a method comprising steps a, b, and c encompasses, for example, a method of performing steps in the order of steps a, c, and b, the order of steps c, b, and a, and the order of steps c, a, and b, etc.

As used in this specification and the appended claims, the singular forms “a,” “an” and “the” includes both singular and plural references unless the content clearly dictates otherwise. For example, the term “inserted at a position” as used herein in reference to a polypeptide sequence refers to insertion at one or more (such as one, two, three, etc.) amino acid positions in the polypeptide sequence. The use of the expression ‘at least’ or ‘at least one’ suggests the use of one or more elements or ingredients or quantities, as the use may be in the embodiment of the disclosure to achieve one or more of the desired objects or results. As such, the terms “a” (or “an”), “one or more”, and “at least one” can be used interchangeably herein.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The suffix “(s)” at the end of any term in the present disclosure envisages in scope both the singular and plural forms of said term.

Numerical ranges stated in the form ‘from x to y’ include the values mentioned and those values that lie within the range of the respective measurement accuracy as known to the skilled person. If several preferred numerical ranges are stated in this form, of course, all the ranges formed by a combination of the different end points are also included.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

As used herein, the terms “include” (any form of “include”, such as “include”), “have” (and “have”), “comprise” etc. any form of “having”, “including” (and any form of “including” such as “including”), “containing”, “comprising” or “comprises” are inclusive and will be understood to imply the inclusion of a stated element, integer or step, or group of elements, integers or steps, but not the exclusion of any other element, integer or step, or group of elements, integers or steps

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

1. A hydrolysate based biostimulant composition comprising a protein-derived component in an amount of about 30% or less with respect to weight of the composition;
wherein said protein-derived component is obtained from a methanotrophic bacterium.

2. The biostimulant composition as claimed in claim 1, wherein the protein-derived component is present in an amount ranging from about 0.01% to 30% with respect to weight of the composition; or wherein the protein-derived component is present in an amount of less than about 10% with respect to weight of the composition; or wherein the protein-derived component is present in an amount ranging from about 0.01% to 10% with respect to weight of the composition.

3. (canceled)

4. The biostimulant composition as claimed in claim 1, wherein the protein-derived component is a protein molecule(s), a component derived from a protein molecule(s), or a combination thereof; or wherein the protein-derived component comprises proteins, peptides, amino acids, enzymes, hormones, or any combination thereof.

5. (canceled)

6. The biostimulant composition as claimed in claim 1, wherein the protein-derived component comprises essential amino acids lysine, threonine, methionine, tryptophan, histidine, valine, phenylalanine, isoleucine, leucine, proline and glycine;
and wherein lysine is in an amount of about 2% to 6%, threonine is in an amount of about 2% to 3%, methionine is in an amount of about 1% to 2%, tryptophan is in an amount of about 0.1% to 1%, histidine is in an amount of about 1% to 4%, valine is in an amount of about 5% to 10%, phenylalanine is in an amount of about 5% to 10%, isoleucine is in an amount of about 5% to 10%, leucine is in an amount of about 3% to 4%, proline is in an amount of about 5% to 13% and glycine is in an amount of about 1% to 8.5%, with respect to weight of total amino acids in the protein-derived component.

7. The biostimulant composition as claimed in claim 1, wherein the protein-derived component comprises histidine in an amount of about 1% to 4%, valine in an amount of about 5% to 10%, isoleucine in an amount of about 5% to 10%, lysine in an amount of about 2% to 6% and proline in an amount of about 5% to 13%, with respect to weight of total amino acids in the protein-derived component.

8. The biostimulant composition as claimed in claim 1, wherein the protein-derived component comprises peptides selected from polypeptides, oligopeptides and a combination thereof;
and wherein the oligopeptides are selected from the group comprising dipeptide, tripeptide, tetrapeptide, pentapeptide, hexapeptide, heptapeptide, octapeptide, nonapeptide, decapeptide, undecapeptide, dodecapeptides, icosapeptide, tricontapeptides, tetracontapeptides and combinations thereof.

9. The biostimulant composition as claimed in claim 1, wherein the protein-derived component comprises peptides having a size greater than 45 kDa (kilodaltons) in an amount of less than 5%, peptides having a size of about 17 kDa to 45 kDa in an amount of less than 5%, peptides having a size of about 1 kDa to 15 kDa in an amount of less than 20%, and peptides having a size lower than 1 kDa in an amount of more than 50% with respect to amount of total peptides in the protein-derived component.

10. The biostimulant composition as claimed in claim 1, wherein the protein-derived component comprises peptides having a size greater than 45 kDa (kilodaltons) in an amount of less than 5%, peptides having a size of about 17 kDa to 45 kDa in an amount of less than 5% and peptides having a size lower than 1 kDa in an amount of more than 50%, with respect to amount of total peptides in the protein-derived component.

11. The biostimulant composition as claimed in claim 1, wherein the methanotrophic bacterium is a gammaproteobacterial methanotroph; or wherein the methanotrophic bacterium is a type I or type X methanotroph belonging to a genus selected from the group comprising Methylococcus, Methylomonas, Methylobacter, Methyloglobulus, Methylovulum, Methylomicrobium, Methylosarcina, Methylosphaera, Methyloprofundus, Methylosoma, Methylocucumis, Methyloparacoccus, Methylogaea, Methylomagnum, Methyloterricola, Methylohalobius, Methylomarinum, Methylomarinovum, Methylocaldum, Methylothermus, Crenothrix and combinations thereof; or wherein the methanotrophic bacteria is Methylococcus capsulatus.

12. (canceled)

13. (canceled)

14. The biostimulant composition as claimed in claim 1, wherein the composition is in a solid form or a liquid form, and comprises at least one non-protein metabolite, at least one culture media component and optionally at least one agriculturally acceptable excipient; or wherein the composition comprises protein-derived component in an amount of about 30% or less, at least one non-protein metabolite in an amount of about 0.01% to 50% and at least one culture media component in an amount of about 0.1% to 50%, by weight of the composition; or wherein the composition comprises protein-derived component in an amount of about 30% or less, at least one non-protein metabolite in an amount of about 0.01% to 30%, at least one culture media component in an amount of about 0.1% to 30% and at least one agriculturally acceptable excipient in an amount of about 0.01% to 90%, by weight of the composition.

15. (canceled)

16. (canceled)

17. The biostimulant composition as claimed in claim 1, wherein the at least one non-protein metabolite is selected from the group comprising lipids, carbohydrates, sugars, nucleic acids, nucleotides, vitamins, organic acids, osmolytes, lipid-derived hormones, minerals and combinations thereof;
wherein the at least one culture media component is selected from the group comprising inorganic nutrient, minerals, ions, salts, buffers and combinations thereof; and
wherein the at least one agriculturally acceptable excipient is selected from the group comprising carrier, protectant, adjuvant, surfactant, stabilizer, preservative, diluent, suspending agent, dispersing agent, cosolvent and combinations thereof.

18. The biostimulant composition as claimed in claim 1, wherein the composition comprises micronutrients: calcium at about 1% to 25%, magnesium at about 1% to 30%, boron at about 0.001% to 1%, iron at about 0.001% to 1% and sodium at about 1% to 20%, with respect to weight of total micronutrients in the composition.

19. The biostimulant composition as claimed in claim 1, wherein the composition:
a. improves or enhances performance of plant,
b. increases availability or efficient utilization of at least one of nitrogen, phosphorus and potassium by the plant,
c. reduces need for external addition of at least one nutrient selected from nitrogen, phosphorus and potassium, either individually or as part of a fertilizer, or
d. any combination of a. to c.

20. A method of:
a) improving or enhancing plant performance, or
b) reducing need of external addition of at least one nutrient or nutrient carrying fertilizer for growth or survival of a plant, wherein the at least one nutrient is selected from the group comprising nitrogen, phosphorus, potassium and combinations thereof,
said method comprising contacting or applying the biostimulant composition of claim 1, to the plant.

21. The method as claimed in claim 20, wherein improving or enhancing plant performance comprises stimulating or promoting a quantitative or qualitative plant attribute selected from the group comprising biomass production, yield, photosynthetic activity, nutritional value, nutrient use efficiency, improvement in plant specific metabolites and combinations thereof; or wherein effect of the improved or enhanced plant performance is measured by:
a. increase in number, size or quality of below ground or aerial biomass selected from the group comprising root, shoot, leaf, flowers, anthers, stigma, stamens, fruits, seeds and combinations thereof,
b. increase in photosynthetic activity or chlorophyll content,
c. increase in protein, dietary fibre, β-carotene, essential oil content, plant specific metabolite(s), or any combination thereof,
d. efficient absorption or utilization of available or externally provided nutrients or minerals, or
e. any combination of a. to d.

22. (canceled)

23. The method as claimed in claim 20, wherein the biostimulant composition is in a solid form or a liquid form; or wherein the biostimulant composition is contacted with or applied to the plant through its soil, or through aerial or non-aerial parts of the plant selected from the group comprising root, shoot, leaf, flower, anther, stigma, stamen, fruit, seed and combinations thereof; or wherein the biostimulant composition improves or enhances the plant performance by about 1% to about 500% or by about 1.5 folds to about 10 folds when compared to a respective performance of a plant not contacted with the biostimulant composition of claim 1; or wherein the composition improves or enhances the plant performance by either increasing availability of or efficient utilization of at least one of nitrogen, phosphorus and potassium by the plant, or both; or wherein the method reduces need for external addition of at least one of nitrogen, phosphorus and potassium for growth or survival of the plant, by at least about 10% to 100%, when compared to the need for addition of respective nitrogen, phosphorus and potassium in a plant not contacted with the biostimulant composition of claim 1.

24. (canceled)

25. (canceled)

26. (canceled)

27. (canceled)

28. (canceled)

29. (canceled)

30. A process of preparing the biostimulant composition of claim 1, said process comprising hydrolysing a biomass comprising methanotrophic bacteria cells and optionally adding agriculturally acceptable excipient, to obtain the biostimulant composition.

31. The process as claimed in claim 30, wherein the biomass is obtained by culturing the methanotrophic bacteria in a cell culture media; or
and wherein the hydrolysing of biomass comprising methanotrophic bacteria cells is carried out by physical method, mechanical method, chemical method or enzymatic method, or any combination thereof; or wherein the process comprises:
hydrolysing the biomass comprising methanotrophic bacteria cells by physical method, mechanical method, chemical method or enzymatic method, or any combination thereof to obtain a hydrolysate comprising soluble and non-soluble fractions,
wherein the biomass comprising methanotrophic bacteria cells is obtained by culturing the methanotrophic bacteria in a cell culture media;
separating the soluble and non-soluble fractions;
processing the soluble fraction of the hydrolysate; and
optionally adding agriculturally acceptable excipient, to obtain the biostimulant composition of claim 1.

32. (canceled)

33. The process as claimed in claim 30, wherein the methanotrophic bacteria is a gammaproteobacterial methanotroph; or
and wherein the gammaproteobacterial methanotroph the methanotrophic bacteria is a type I or type X methanotroph belonging to genus selected from the group comprising Methylococcus, Methylomonas, Methylobacter, Methyloglobulus, Methylovulum, Methylomicrobium, Methylosarcina, Methylosphaera, Methyloprofundus, Methylosoma, Methylocucumis, Methyloparacoccus, Methylogaea, Methylomagnum, Methyloterricola, Methylohalobius, Methylomarinum, Methylomarinovum, Methylocaldum, Methylothermus, Crenothrix and combinations thereof; or the methanotrophic bacteria is Methylococcus capsulatus.

34. (canceled)

35. (canceled)

36. (canceled)

37. (canceled)

38. A biostimulant product comprising:
a) the composition as claimed in any of the claim 1; and
b) a composition comprising a microbial consortium of whole cells, wherein at least 50% whole cells are methanotrophic bacteria cells; wherein the microbial consortium comprises less than 50% whole cells of a non-methanotroph or a plant growth-promoting microbe (PGPM);
wherein the PGPM is selected from a group comprising nitrogen fixing microbe, phosphate solubilizing microbe, mineral solubilizing microbe, phytohormone secreting microbe, organic acids secreting bacteria, plant beneficial microbe and combinations thereof.

39. (canceled)
